(19) United States
(12) Patent Application Publication
(10) Pub. No.: US 2026/0153104 A1
(43) Pub. Date: Jun. 4, 2026

(54) COMPRESSED AIR SUPPLY UNIT, COMPRESSED AIR SUPPLY SYSTEM, VEHICLE, AND OPERATING METHOD

(71) Applicant: ZF CV Systems Europe BV, Brussels (BE)

(72) Inventors: Uwe Stabenow, Laatzen (DE); Jörg Meier, Hessisch Oldendorf (DE)

(21) Appl. No.: 19/459,398

(22) Filed: Jan. 26, 2026

Related U.S. Application Data
(63) Continuation of application No. PCT/EP2024/069597, filed on Jul. 11, 2024.

(30) Foreign Application Priority Data
Jul. 26, 2023 (DE) 10 2023 119 856.4

(51) Int. Cl. F15B 21/048; B60S 1/54; B60S 1/56; F15B 21/0427

(52) U.S. Cl. CPC F15B 21/048; B60S 1/54; B60S 1/56; F15B 21/0427

(57) ABSTRACT

A compressed air supply unit includes a main pneumatic line from the compressed air connection to the compressed air supply connection and includes an air dryer arranged in the main pneumatic line for drying the compressed air. A branching line branches off from the main pneumatic line between the compressed air connection and the air dryer and reconnects to the main pneumatic line between the air dryer and the compressed air supply connection. A main line switch valve is arranged upstream of the branching line between the compressed air connection and the air dryer and blocks the main pneumatic line in a first operating mode. A method is for operating a compressed air supply system. A vehicle and/or a compressed air supply system have a compressed air supply unit.

### CROSS-REFERENCE TO RELATED APPLICATIONS

This application is a continuation application of international patent application PCT/EP 2024/069597, filed Jul. 11, 2024 designating the United States and claiming priority from German application 10 2023 119 856.4, filed Jul. 26, 2023, and the entire content of both applications is incorporated herein by reference.

### TECHNICAL FIELD

The present disclosure relates to a compressed air supply unit for a sensor cleaning device of a vehicle, in particular a passenger car, having
a compressed air port for connection to a compressed air generator,
a compressed air supply port for connection to a compressed air consumer, in particular a sensor cleaning device,
a pneumatic main line for conducting compressed air from the compressed air port to the compressed air supply port in a filling direction, and
an air dryer, which is arranged in the pneumatic main line, for drying the compressed air, which is conducted in the filling direction, in the pneumatic main line.

### BACKGROUND

In vehicles, compressed air supply units are used to supply compressed air consumers with compressed air. For this purpose, compressed air is provided to the compressed air supply unit via the compressed air port by a compressed air generator, such as a compressing device or compressor. Compressing devices or compressors are used as synonyms in the present description and refer to assemblies which compress air. Such a compressing device together with the compressed air supply unit forms a compressed air supply system. Such a compressed air supply system is preferably actuated via an electronic control device, for example a control unit (ECU). Compressed air supply systems of this type are also used in particular for supplying compressed air to sensor cleaning devices as compressed air consumers. Preferably, such compressed air supply systems are configured to provide compressed air at a supply pressure of 5 bar and a volume flow rate of preferably 30-100 l/min.

Sensor cleaning devices for vehicles are also known. Via a sensor cleaning device, surfaces on a vehicle, in particular sensor surfaces of sensors, can be cleaned via at least one cleaning fluid, for example compressed air. The effect which can be achieved via, in particular regularly carried out, cleaning of sensor surfaces on the vehicle is that sensors are less soiled and thus function more reliably. A clean sensor surface thus advantageously increases the reliability of driver assistance functions and/or partially autonomous and/or autonomous driving functions of a vehicle. The safety of the vehicle, its occupants and other road users is thus advantageously increased by a sensor cleaning device.

Sensor cleaning devices which use compressed air as a cleaning fluid are connected as compressed air consumers to a compressed air supply unit. The compressed air provided for the sensor cleaning device by the compressed air supply unit has to be dried in order to prevent corrosion and damage caused by frost at temperatures below freezing, and functional impairment to lines and the sensor cleaning device. The substrate in the air dryer is basically configured to adsorb moisture from the compressed air flowing through the air dryer, but the substrate can only adsorb moisture up to a maximum saturation. In order to maintain the operation of the air dryer, the air dryer is therefore usually regenerated either regularly or at the latest when the saturation limit is reached. Regeneration is understood here as meaning the dehumidification of the substrate used in the air dryer for drying purposes. In order to dehumidify the substrate, air drier than the substrate then has to be conducted through the air dryer. In the process, this drier air binds some of the adsorbed moisture and thus reduces the degree of saturation of the substrate. The operating period of the air dryer is limited here by the saturation of the substrate located in the air dryer. If the regeneration of the air dryer is omitted, when the maximum saturation of the substrate is reached, the air dryer or the substrate located in the air dryer has to be replaced.

The challenge in compressed air supply units for sensor cleaning devices is that the compressed air provided at the compressed air supply port cannot be returned into the compressed air supply unit and instead is ejected for cleaning the sensors. Thus, unlike in the case of known compressed air supply units, as shown for example in DE 10 2017 010 772 A1, compressed air which has already been dried by the air dryer and can be used for regenerating the air dryer does not remain in the compressed air supply unit.

The operating period of the compressed air supply unit for sensor cleaning devices therefore decisively depends on the operating period of the air dryer and its degree of saturation. The operating period of such a compressed air supply unit can thus only be realized to date by an increase in the amount of substrate - that is, by a larger air dryer. However, due to space limitations, such a solution is perceived as a disadvantage.

### SUMMARY

It is an object of the disclosure to specify a compressed air supply unit, a compressed air supply system, a vehicle, and an operating method, which overcome at least one of the disadvantages known from the prior art. In particular, it is an object of the present disclosure is to increase the operating period of a compressed air supply unit of the type mentioned at the beginning and at the same time to realize a compact configuration of the compressed air supply unit.

In a first aspect of the disclosure, the object relating to a device is achieved by a device according to various embodiments of the disclosure. According to the first aspect of the disclosure, in the case of a compressed air supply unit for, in particular, open pneumatic systems, the disclosure proposes a branch line which branches off from the pneumatic main line between the compressed air port and the air dryer and reconnects between the air dryer and the compressed air supply port, and a pneumatic main line switching valve which is arranged downstream of the branch line in the filling direction, between the compressed air port and the air dryer in the pneumatic main line, and is configured, in a first operating mode, to block the pneumatic main line in the filling direction, and, in a second operating mode, to open the pneumatic main line in the filling direction pneumatically to enable the flow to pass through it.

The disclosure makes use of the finding that the necessity of extensive drying of the compressed air provided at the compressed air supply port is weather-dependent. For example, at temperatures well above freezing and especially in tropical or subtropical climate zones, dry compressed air does not need to be provided at the compressed air supply port in order to supply, for example, a sensor cleaning device therewith. The sensor cleaning device uses the compressed air provided at the compressed air supply port to clean sensors, with the aim of avoiding an impairment in function. If a moisture film forms in any case on the sensors due to the weather conditions and if there is furthermore no risk of the wet freezing, these sensors can also be cleaned with only partially dehumidified or moist compressed air.

The inventors therefore advantageously recognized that compressed air provided at the compressed air supply port only has to be dried as required and in this way the air dryer can be to a certain extent “conserved”. A branch line, which branches off from the pneumatic main line upstream of the air dryer and reconnects downstream of the air dryer, provides a bypass via which compressed air can be conveyed in the direction of the compressed air supply port. The pneumatic main line switching valve which, in a first operating mode, selectively blocks the pneumatic main line in the filling direction, does not convey compressed air in the filling direction via the air dryer toward the compressed air supply port. In such a mode, the air dryer is consequently not saturated and the operating period of the compressed air supply unit can be increased overall. The supply of the downstream pneumatic system with compressed air which is not dried by the air dryer also continues to be ensured via the branch line.

The filling direction within the meaning of the disclosure denotes the direction of the compressed air, which is conducted through a line, from the compressed air port to the compressed air supply port. The pressure-conducting line may be the pneumatic main line or a branch line which is configured to conduct compressed air to the compressed air supply port.

According to various embodiments, the compressed air supply unit includes a branch line switching valve which is arranged in the branch line and is configured to selectively open the branch line pneumatically to enable the flow to pass through it and to block same. In embodiments in which the single air dryer is arranged in the main line, the branch line switching valve is configured, in the first operating mode, to open the branch line in the filling direction pneumatically to enable the flow to pass through it and to block same in the second operating mode. The possibility of blocking the branch line as required can ensure that, in critical weather conditions, only compressed air dried by air dryers is provided at the compressed air supply port. Thus, damage and especially corrosion of the lines or of the compressed air consumer can be safely avoided.

Alternatively, According to various embodiments, the compressed air supply unit includes a branch line throttle which is arranged in the branch line and is configured to increase the flow resistance of the branch line in relation to the pneumatic main line. In the second operating mode, the branch line throttle ensures that only a portion of the compressed air defined by the flow resistance of the throttle flows through the branch line and the preferably predominant portion continues to flow through the pneumatic main line and thus through the air dryer. Alternatively, in the second operating mode, the branch line switching valve ensures that no compressed air flows through the branch line and instead continues to flow through the pneumatic main line and thus through the air dryer. This ensures adequate air drying in the second operating mode. According to various embodiments, the branch line throttle is furthermore assigned a throttle check valve which is arranged in the filling direction upstream of the branch line throttle. The throttle check valve is preferably configured to open at an opening pressure in the filling direction upstream of the branch line throttle, which pressure is higher than a pressure difference upstream and downstream of the branch line throttle.

According to various embodiments, the compressed air supply unit furthermore includes a venting port for venting the compressed air supply unit, and a venting line, which branches off from the pneumatic main line, for conducting compressed air to the venting port. Pressure can thus be released from the compressed air supply unit. According to this embodiment, a return direction describes in particular the direction of the compressed air, which is conducted through a line, from the compressed air supply port to the venting port. The pressure-conducting line may be the pneumatic main line or a branch line from which a venting line branches off toward the venting port.

According to a preferred embodiment, the compressed air supply unit includes a pneumatic assembly which is assigned to the compressed air supply port and is configured to distribute the compressed air in the compressed air supply unit.

According to various embodiments, the compressed air supply unit furthermore includes a water separator which is arranged in the pneumatic main line between the compressed air port and the air dryer, in particular between the compressed air port and the pneumatic main line switching valve. The water separator, which separates a portion of the moisture from the compressed air provided at the compressed air port, slows down the saturation of the substrate in the air dryer. Thus, the operating period of the compressed air supply unit is increased even in environments that require drying of the compressed air via the air dryer due to the weather.

It is furthermore preferred that the water separator has a condensation dryer for condensing moist compressed air and a drain member, in particular a drain valve, for draining condensate. The compressed air provided by the compressed air generator, such as in particular a compressing device or compressor, usually has high temperatures as a result of the compression. Portions of the moisture can be separated as condensate from the hot compressed air by a condensation dryer, expediently by cooling the moist compressed air, and, finally, can drained through a drain member. According to various embodiments, such a condensation dryer has a liquid cooling system, in particular a water cooling system.

The main line switching valve is preferably a magnetic switching valve which is configured to be signal-conductingly connected to an electronic control device. The magnetic switching valve is preferably configured as a 2/2-way directional control valve. The magnetic directional control valve is particularly preferably configured as a normally closed valve.

Such a control device preferably includes one or more communicating control units. Thus, for example, a first control unit can be configured for controlling the compressed air consumer, a second control unit can be configured for controlling the compressed air supply system, and a third control unit can be configured for controlling the compressed air generator. The communication between such control units enables a reliable exchange of data and common control of the compressed air supply system and of the compressed air consumer and of the compressed air generator.

According to various embodiments, the compressed air supply unit has an external ventilation device assigned to the water separator. According to various embodiments, the external ventilation device includes a fan. The water separator is thus assisted by the ventilation device in the cooling of the hot compressed air provided at the compressed air port. This thus results in stronger cooling of the hot compressed air and therefore in an increased degree of dehumidification of same.

According to a preferred embodiment, the air dryer is a first air dryer and the compressed air supply unit furthermore has a second air dryer which is arranged in the branch line. In the event of saturation of the first air dryer, safe operation can be ensured even at temperatures below freezing. This increases the operational readiness of the compressed air supply unit. The second air dryer, which is, for example, smaller than the first air dryer, can be used to ensure an emergency operation in the event of saturation of the first air dryer.

According to an alternative preferred embodiment, the branch line is a first branch line, and the air dryer is a first air dryer, and the compressed air supply unit furthermore includes a second branch line which branches off between the compressed air port and the first air dryer and reconnects between the air dryer and the compressed air supply port, and a second air dryer which is arranged in the second branch line.

Thus, the compressed air supply unit can provide dried compressed air via a second air dryer for regenerating the first air dryer. The compressed air dried by the second air dryer is preferably conducted through the pneumatic main line counter to the filling direction, in order to regenerate the first air dryer - that is, to remove the adsorbed moisture again from the substrate located in the first air dryer. Via the first branch line, even during the regeneration of the first air dryer, compressed air can thus continue to be provided at the compressed air supply port for the operation of a pressure consumer, such as a sensor cleaning device. In the same way as the first air dryer can be regenerated, regeneration of the second air dryer is furthermore also possible and also in this case a parallel supply of a compressed air consumer via the first branch line is possible. In this case, compressed air is dried via the pneumatic main line and the first air dryer and conveyed via the second branch line through the second air dryer counter to the filling direction, that is, in the direction of the compressed air port. If a water separator, as described above according to a preferred development, is provided, the first air dryer can also be regenerated via the first branch line and, simultaneously, via the second branch line, dried compressed air can be provided at the compressed air supply port. This means that the compressed air supply unit can be permanently operational ready even at temperatures below freezing.

According to various embodiments, the venting line is a first venting line and the compressed air supply unit furthermore has a second venting line, which branches off from the second branch line, to the venting port. Through such a second venting line, the compressed air re-emerging from the second air dryer counter to the filling direction can be discharged by the corresponding second venting line, which is assigned to the second air dryer, analogously to the regeneration of the first air dryer.

According to various embodiments, the compressed air supply unit furthermore has a main line throttle which is arranged in the pneumatic main line and is configured to interact with the branch line throttle in order, in the second operating mode, to set a volume flow ratio between the pneumatic main line and the branch line. According to various embodiments, the main line throttle and/or the branch line throttle is a controllable throttle or a controllable throttle valve. The volume flow ratio between the compressed air, which is conducted through the pneumatic main line and the branch line in the second operating mode, can thus be controlled.

According to various embodiments, the compressed air supply unit, in particular the pneumatic assembly, has a shut-off valve which is arranged in the pneumatic main line between the air dryer and the compressed air supply port and is configured to cooperate with the pneumatic main line switching valve and, in the first operating mode, to block a return of compressed air counter to the filling direction. In the first operating mode, the pneumatic main line is thus blocked both in the filling direction and counter to the filling direction such that the air dryer is protected in relation to compressed air which is still moist, and a progressive saturation of the air dryer is avoided.

In embodiments in which the air dryer in the pneumatic main line is a first air dryer, the shut-off valve is correspondingly arranged in the pneumatic main line in the filling direction downstream of the first air dryer. The air dryer or the first air dryer is thus pneumatically decoupled from the branch line. During operation of the compressed air supply unit in the first operating mode, in which the compressed air is provided at the compressed air supply port exclusively via the branch line, no compressed air which is still moist reaches the air dryer and furthers the saturation thereof. Such a shut-off valve is preferably a switchable shut-off valve, particularly preferably an electrically controllable 2/2-way directional control valve. In addition, such a pneumatic decoupling of the air dryer from the branch line conducting moist compressed air allows a more accurate prediction of the degree of saturation of the particular air dryer.

According to various embodiments, in embodiments in which a second air dryer is provided, the pneumatic assembly furthermore includes a second shut-off valve which is assigned to the second air dryer and cooperates with the branch line switching valve and is arranged between the second air dryer and the compressed air supply port. In embodiments in which the second air dryer is arranged in the single branch line, the branch line shut-off valve is configured to block the branch line in the second operating mode. Thus, in the second operating mode, in which compressed air is conducted via the pneumatic main line to the compressed air supply port, the second air dryer can be pneumatically decoupled from the pneumatic main line and thus the saturation of the second air dryer can be calculated more precisely. In embodiments in which the second air dryer is arranged in the second branch line, the second shut-off valve is preferably configured to block the second branch line in the first operating mode. Thus, the second air dryer can also be pneumatically decoupled from the first branch line, which conducts moist or partially dehumidified compressed air in the first operating mode.

In embodiments in which the branch line is a first branch line, the corresponding branch line switching valve is a first branch line switching valve, which is arranged in the first branch line, and a second branch line switching valve is arranged in an optionally present second branch line.

According to various embodiments, the compressed air supply system furthermore includes a pressure sensor which is arranged upstream of the branch line or the venting line and is configured for detecting the pressure in the pneumatic main line between the water separator and the branching-off branch line. In particular, the branch line may also be the first branch line and/or the second branch line. The pressure in the pneumatic main line can thus be monitored, with the pressure sensor preferably communicating with the electronic control device, and at least one of the switching valves and/or the pneumatic assembly being controlled on the basis of the signals provided by the pressure sensor.

In order to achieve the object, the disclosure leads in a second aspect to a compressed air supply system. According to the second aspect, the compressed air supply system for a sensor cleaning device of a vehicle, in particular a passenger car, includes a compressed air generator, in particular a compressing device, for providing compressed air at a compressed air port, and a compressed air supply unit, which is connected to the compressing device via the compressed air port, for providing compressed air for a compressed air consumer, in particular a sensor cleaning device. The object mentioned at the beginning is achieved in the case of such a compressed air supply system in that the compressed air supply unit is configured according to the first aspect of the disclosure. Preferred embodiments and advantages which have been described with respect to the first aspect of the disclosure are therefore also advantages and preferred embodiments of the second aspect of the disclosure, and vice versa.

According to various embodiments, the compressed air supply system furthermore includes an additional compressed air source, which is connectable to a control device and is configured to be actuated by the control device for connecting to the pneumatic main line as required. Thus, an additional compressed air source is added in addition to the compressed air generator. Via an additional compressed air source, the available compressed air amount, that is, the available volume flow, is increased, and varying system requirements can be reacted to.

Furthermore, the compressed air source is preferably configured to provide an input pressure above the supply pressure of, for example, 5 bar at the compressed air port. The efficiency of the water separator and thus of the pre-drying of the compressed air is improved by the increased input pressure such that the addition of the compressed air source to increase the input pressure slows down the saturation of the air dryer. In detail, the temperature of the compressed air provided by the compressing device, and thus also the amount of water per m³, increases as a result of the increased input pressure. The higher temperature makes it easier to cool the compressed air in the water separator to temperatures below the condensation temperature since the condensation temperature increases as a result of the accompanying increase in the amount of water per m³ of compressed air.

It is preferred that the compressed air generator is a first compressing device and the compressed air source moreover includes a second compressing device which is configured to provide compressed air at the compressed air port. Via two compressing devices, compressed air can be provided at an increased volume flow and an increased pressure at the compressed air port, or the compressed air generator can be switched off as required, with compressed air preferably being provided by the compressing device. Alternatively or in addition, the compressed air source includes a reservoir which is fluidically connected to the pneumatic main line and/or to the second branch line. Via such a reservoir, compressed air can be provided at an increased volume flow and an increased pressure at the compressed air port, or the compressed air generator can be switched off as required, with compressed air preferably being provided by the compressed air source, that is, the reservoir.

The pneumatic assembly preferably includes a controllable throttle valve, which is configured to throttle compressed air which is conducted in the filling direction to the compressed air supply port. For this purpose, the throttle valve preferably has a throttle point with a variable flow cross section. The throttle valve preferably has a control pressure line and is configured to regulate the flow cross section depending on the control pressure. The control pressure line is preferably connected to the pneumatic main line downstream of the throttle point. Alternatively, the throttle valve is preferably electrically controllable and configured to regulate the flow cross section by actuation via the control device. The throttle valve influences the compressed air flow by changing the flow cross section in the pneumatic main line. If the valve reduces the flow cross section, this obstructs the flow of compressed air in the pneumatic main line, thereby increasing the resistance to the compressed air flow. This in turn increases the back pressure upstream of the throttle point. The throttle valve is configured to throttle the pressure at the supply port, that is, downstream of the throttle valve, to the supply pressure and/or to the supply volume flow.

The pressure is throttled to the supply pressure by a reduction in the flow cross section in the region of the throttle point, followed by expansion of the compressed air passing through the throttle point. If the flow cross section through the throttle valve is reduced to a maximum, no more compressed air is directed to the supply port.

To throttle the volume flow, the throttle valve cooperates in particular with a pressure limiting valve, such as a venting check valve arranged in the venting line, with the flow cross section in the throttle valve being reduced until the back pressure upstream of the throttle valve reaches the pressure limiting valve and provides a sufficient pressure for opening the valve. The venting check valve preferably opens at a pressure of at least 0.5 bar. By virtue of such a control of the throttle valve, the input volume flow provided at the compressed air port can be divided into the supply volume flow, for provision at the compressed air port, and an excess portion which is returned counter to the filling direction for the regeneration of the air dryer.

According to various embodiments, the pneumatic assembly includes at least one first check valve opening in the filling direction and a bypass line which branches off downstream of the check valve and reconnects upstream of the check valve and has a second check valve opening in the return direction, that is, counter to the filling direction. According to various embodiments, the pneumatic assembly furthermore includes a throttle valve which is arranged in the bypass line downstream of the second check valve in the return direction and is configured to throttle compressed air, which is conducted to the air dryer counter to the filling direction. For this purpose, the throttle valve preferably has a throttle point with a variable flow cross section.

The throttle valve preferably has a control pressure line and is configured to regulate the flow cross section depending on the control pressure. The control pressure line is preferably connected to the bypass line downstream of the throttle point in the return direction, that is, counter to the filling direction. The first check valve is preferably arranged in the pneumatic main line, the first check valve and the second check valve being arranged between the (first) air dryer and the compressed air supply port. Alternatively or in addition, the first check valve is preferably arranged in the (second) branch line, the first check valve and the second check valve being arranged between the second air dryer and the compressed air supply port. For the return in the branch line or in the pneumatic main line, the compressed air therefore inevitably has to pass through the controllable throttle valve, which is configured to throttle the pressure of the compressed air flowing to the respective air dryer or to completely block the line. The compressed air is then preferably conducted via a throttle arranged downstream of the air dryer in the filling direction and expanded by the throttle. The accompanying expansion of the compressed air reduces its relative humidity.

According to various embodiments, in a third operating mode, the pneumatic assembly is configured to allow a return of compressed air from the first branch line and/or the pneumatic main line into the second branch line counter to the filling direction. Regeneration of the second air dryer can thus moreover be controlled via the pneumatic assembly.

To achieve the object, in a fourth aspect, the disclosure leads to an, in particular open, pneumatic system of a vehicle, in particular passenger car having a compressed air supply system according to the second aspect of the disclosure and a sensor cleaning device which is connected to the compressed air supply unit via the compressed air supply port. In a third aspect, the object mentioned at the beginning is thus achieved by the compressed air supply system of the pneumatic system being configured according to the second aspect of the disclosure. Preferred embodiments and advantages which have been described with respect to the second aspect of the disclosure are therefore also advantages and preferred embodiments of the fourth aspect of the disclosure, and vice versa.

It is preferred that the sensor cleaning device has at least one heatable nozzle valve. A heatable nozzle valve reduces the risk of frost damage at temperatures close to freezing. The threshold value from which only compressed air dried by the air dryer may be conducted to the compressed air supply port is accordingly shifted to lower temperatures.

According to various embodiments, one, a plurality, or all of the following are configured as normally closed solenoid directional control valves:
the at least one main line switching valve,
the at least one branch line switching valve,
the at least one nozzle valve of a sensor cleaning device connected to the compressed air supply unit,
the at least one venting valve, and
the compressor venting valve,

the solenoid directional control valves having a coil for generating a magnetic force and an armature, which is movable by the magnetic force counter to a spring force acting in the direction of a valve seat, and being configured to be moved away from the valve seat counter to the spring force by energizing with an opening control current and to bear against the valve seat by energizing with a heating control current which is smaller than the opening control current, the coil being configured to heat the solenoid directional control valve when the heating control current is present. The possibility of heating the mentioned valves reduces the risk of frost damage of the pneumatic system as a whole. In addition to the sensor cleaning device or other compressed air consumers, this also relates in particular to the compressed air supply unit.

In order to achieve the object, in a fourth aspect, the disclosure leads to a vehicle having a compressed air supply system. According to the fourth aspect of the disclosure, the vehicle, in particular a passenger car, includes a pneumatic consumer, in particular a sensor cleaning device which is connected to a compressed air supply port, a compressed air supply system for providing compressed air in the compressed air supply port, and an electronic control device for controlling the compressed air supply system. The object mentioned at the beginning is achieved in a fourth aspect in that the compressed air supply system of the vehicle is configured according to the second aspect of the disclosure and, furthermore, in that the electronic control device (ECU) is signal-conductingly connected at least to the pneumatic main line switching valve, in particular also to the branch line switching valve and/or preferably to the pneumatic assembly. Preferred embodiments and advantages which have been described with respect to the second aspect of the disclosure are therefore also advantages and preferred embodiments of the fourth aspect of the disclosure, and vice versa.

The control device is thus configured to actuate at least the pneumatic main line switching valve and is preferably signal-conductingly connected to the pressure sensor. Thus, the control device can selectively block the pneumatic main line and thus only use the air dryer as required, in the event that the weather conditions actually require drying of the compressed air provided at the compressed air supply port. The air dryer is thus “conserved”. According to various embodiments, the control device is configured for actuating the first and in particular also second branch line switching valve and, if necessary, for controlling the first or second shut-off valve. According to various embodiments, the control device is a central vehicle controller which receives signals from further sensors of the vehicle and is configured to detect critical weather conditions that require the compressed air provided at the compressed air supply port to be dried.

The actuation of a switching valve for blocking a pneumatic line can be understood to mean energizing it and de-energized switching of it, that is, the absence of it being energized, depending on the configuration of the respective valve. Accordingly, the actuation of a switching valve for releasing a pneumatic line can be understood to mean energizing it and de-energized switching of it, depending on the configuration of the respective valve.

According to various embodiments, the control device is signal-conductingly connected to a venting valve in a venting line branching off from the pneumatic main line. According to various embodiments, the control device is configured to control the pressure within the compressed air supply unit depending on the input pressure detected by the pressure sensor, in particular at the compressed air port, and particularly preferably to limit the pressure to a maximum pressure of preferably 5 bar at the compressed air supply port. Thus, for example, thermally induced pressure fluctuations can be reacted to. In particular, however, the compressed air supply unit can be supplied with a pressure above the supply pressure of 5 bar. As a result, as described above, the temperature of the compressed air provided at the compressed air port and its humidity per m3 of compressed air increases, thereby improving the efficiency of the water separator.

The control device is preferably configured to connect the compressed air source to the pneumatic main line as required, depending on the supply requirement of the compressed air consumer. An increased supply requirement in relation to the supply volume flow may occur, for example, when all of the nozzles of a sensor cleaning device are to be provided with compressed air. As a result of the fact that, depending on this supply requirement, the control device can add an additional compressed air source, it is possible to react to such supply requirements, and a sufficient supply volume flow at the supply pressure for supplying all of the nozzles can be provided.

According to various embodiments, the control device is configured to connect the compressed air source to the pneumatic main line as required, depending on sensor signals. The compressed air supply system preferably includes at least one temperature sensor which is configured for monitoring a temperature of the compressed air generator, in particular of the compressing device or compressor, and for providing sensor signals, with the control device being signal-conductingly connected to the temperature sensor. The compressed air generator may have to be switched off in the event of imminent overheating. The addition of the compressed air source, depending on the sensor signals of the temperature sensor monitoring the compressed air generator, enables such imminent overheating to be detected and the operation of the compressed air supply system can continue to be maintained by the compressed air source.

Alternatively or in addition, the control device is preferably configured to monitor a degree of saturation of the air dryer and to connect a or the compressed air source to the pneumatic main line as required. Furthermore, by addition of the compressed air source, a volume flow at the compressed air port, that is, an input volume flow, above the supply volume flow of, for example, 30 l/min, can furthermore preferably be provided. An increased input volume flow which is above the supply volume flow to be provided at the compressed air supply port is particularly advantageous in the regeneration of the first or second air dryer or in a simultaneous regeneration of the air dryer and provision of compressed air at the compressed air supply port. The increased input volume flow improves the efficiency of the regeneration, and therefore the addition of the compressed air source is advantageous in particular in the event of a high saturation or a high degree of saturation. In this way, the degree of saturation can be quickly reduced. Particularly advantageously, the addition of the compressed air source for the provision of an input volume flow above the supply volume flow makes it possible for two air dryers to be regenerated simultaneously.

The control device is furthermore preferably configured to selectively energize one, a plurality or all of the following solenoid directional control valves with the opening control current and the heating control current:
the at least one main line switching valve,
the at least one branch line switching valve,
the at least one nozzle valve,
the at least one venting valve, and
the compressor venting valve.

The possibility of heating the valves mentioned reduces the risk of frost damage of the pneumatic system and a functional impairment as a whole. In addition to the sensor cleaning device or other compressed air consumers, this also relates in particular to the compressed air supply unit. The use of the coil, which is in any case present, of the solenoid directional control valves makes it possible to dispense with additional heating elements. It should be understood that heating of the solenoid directional control valves is necessary in particular before they are opened since they remain in the closed state for longer periods of time. A functional impairment due to icing is a threat in particular when a possibly iced-up valve or its armature is moved. By heating the valve, which preferably takes place continuously during operation, energizing the solenoid directional control valve before it actually opens prevents it from freezing.

The object mentioned at the beginning is furthermore achieved in a fourth aspect by a method. A method for operating a compressed air supply system, in particular a compressed air supply system according to the second aspect of the disclosure, preferably includes the steps of:
a) providing compressed air at a compressed air port which is connected to a compressed air supply port via a pneumatic main line,
b) drying the dehumidified compressed air, which is conducted in the pneumatic main line in a filling direction to the compressed air supply port, with an air dryer in a second operating mode of a pneumatic main line switching valve,
c) blocking the pneumatic main line in the filling direction in a first operating mode of the pneumatic main line switching valve,
d) conducting compressed air through a branch line in the filling direction in the first operating mode, which branch line branches off from the pneumatic main line between the compressed air port and the air dryer and reconnects between the air dryer and the compressed air supply port.

By conducting compressed air through the branch line branching off from the pneumatic main line and blocking the pneumatic main line in the first operating mode of the pneumatic main line switching valve, the air dryer is not used for drying and therefore its saturation is slowed down. In the second operating mode, however, the compressed air is conducted through the pneumatic main line and dried by the air dryer. The method enables the air dryer to thus be selectively used only in weather conditions which also actually require drying of the compressed air provided at the compressed air supply port. In non-critical weather conditions, such as high temperatures or subtropical conditions, the compressed air can be conducted exclusively via the branch line, so that saturation of the air dryer is avoided or reduced. The method for operating a compressed air supply system thus also appropriates the advantages described above with respect to the first aspect and the second aspect of the disclosure. The preferred embodiments and advantages described with respect to the first two aspects are thus equally preferred embodiments and advantages with respect to the method, and vice versa.

According to various embodiments, the method furthermore includes at least one of the following steps:
e) opening a branch line pneumatically to enable the flow to pass through it in the direction of the compressed air supply port in the first operating mode,
f) blocking the branch line by a pneumatic branch line switching valve in the second operating mode,
g) returning compressed air from a first branch line and/or a second branch line into the pneumatic main line counter to the filling direction in a third operating mode.
h) returning compressed air from a first branch line and/or the pneumatic main line into a second branch line counter to the filling direction in a fifth operating mode,
i) distributing compressed air from the branch line in a fourth operating mode such that a first portion of the compressed air is returned into the pneumatic main line counter to the filling direction and, furthermore, a second portion of the compressed air is provided at the compressed air supply port, wherein step i) preferably includes receiving control signals and controlling the first portion and the second portion depending on the control signals received by a pneumatic assembly.

By selectively opening the branch line and blocking the branch line, the latter can be used as required to provide compressed air at the compressed air supply port. In particular, in non-critical weather conditions, compressed air can be provided via the branch line and, for example, in critical weather conditions, that is, in particular at temperatures below freezing, only compressed air can be conducted via the air dryer toward the compressed air supply port.

Furthermore, the return of compressed air into the pneumatic main line counter to the filling direction in a first operating mode allows the air dryer to be regenerated and thus increases the range of the compressed air supply system. In a corresponding manner, via the return of compressed air into the second branch line counter to the filling direction in a second operating mode, regeneration of an optionally present second air dryer is also possible. By distributing compressed air from the branch line in a second operating mode, it is possible in parallel for both compressed air to be provided at the compressed air supply port and for at least partially dehumidified compressed air to be used to regenerate the respective air dryer.

### BRIEF DESCRIPTION OF DRAWINGS

The invention will now be described with reference to the drawings wherein:

FIG. 1 shows a compressed air supply system in a perspective view;

FIG. 2A shows a compressed air supply unit for a compressed air supply system according to FIG. 1 according to a first embodiment in a first operating mode;

FIG. 2B shows the compressed air supply unit according to FIG. 2A in a second operating mode;

FIG. 3A shows a compressed air supply unit for a compressed air supply system according to FIG. 1 according to a second embodiment in a first operating mode;

FIG. 3B shows the compressed air supply unit according to FIG. 3A in a second operating mode;

FIG. 3C shows the compressed air supply unit according to FIG. 3A in a third operating mode;

FIG. 4A shows a compressed air supply unit for a compressed air supply system according to FIG. 1 according to a third embodiment in a first operating mode;

FIG. 4B shows the compressed air supply unit according to FIG. 4A in a second operating mode;

FIG. 4C shows the compressed air supply unit according to FIG. 4A in a third operating mode;

FIG. 5A shows a compressed air supply unit for a compressed air supply system according to FIG. 1 according to a fourth embodiment in a first operating mode;

FIG. 5B shows the compressed air supply unit according to FIG. 5A in a second operating mode;

FIG. 5C shows the compressed air supply unit according to FIG. 5A in a third operating mode;

FIG. 5D shows the compressed air supply unit according to FIG. 5A in a fourth operating mode;

FIG. 5E shows the compressed air supply unit according to FIG. 5A in a fifth operating mode;

FIG. 6A shows a compressed air supply unit for a compressed air supply system according to FIG. 1 according to a fifth embodiment in a first operating mode;

FIG. 6B shows the compressed air supply unit according to FIG. 6A in a second operating mode;

FIG. 6C shows the compressed air supply unit according to FIG. 6A in a third operating mode;

FIG. 6D shows the compressed air supply unit according to FIG. 6A in a fourth operating mode;

FIG. 7A shows a compressed air supply unit for a compressed air supply system according to FIG. 1 according to a fifth embodiment in a first operating mode;

FIG. 7B shows the compressed air supply unit according to FIG. 7A in a second operating mode;

FIG. 8 shows a vehicle having a compressed air supply system schematically in a first embodiment;

FIG. 9 shows a vehicle having a compressed air supply system schematically in a second embodiment;

FIG. 10 shows a vehicle having a compressed air supply system schematically in a third embodiment;

FIG. 11 shows a solenoid directional control valve for a vehicle according to FIGS. 8 to 9;

FIG. 12A shows a first embodiment of a pneumatic assembly;

FIG. 12B shows a second embodiment of a pneumatic assembly;

FIG. 12C shows a third embodiment of a pneumatic assembly;

FIG. 12D shows a fourth embodiment of a pneumatic assembly; and

FIG. 13 shows schematically a method for operating a compressed air supply system according to FIG. 1.

### DETAILED DESCRIPTION

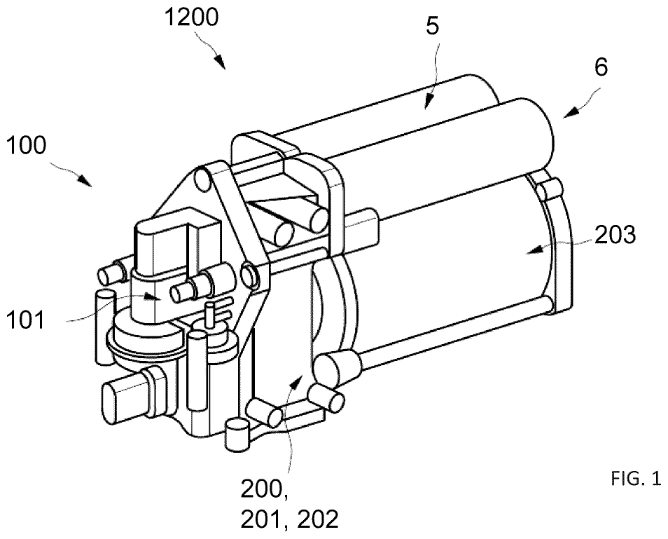

The compressed air supply system 1200 according to FIG. 1 includes a compressed air supply unit 100 and a compressed air generator 200, which is preferably in the form of a compressing device 201 or compressor 202. The compressor 202 is driven by an electric motor 203.

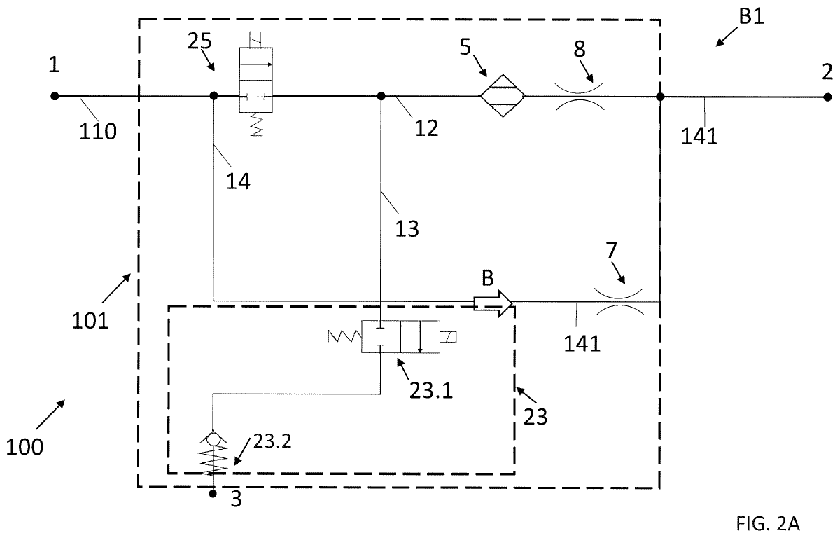

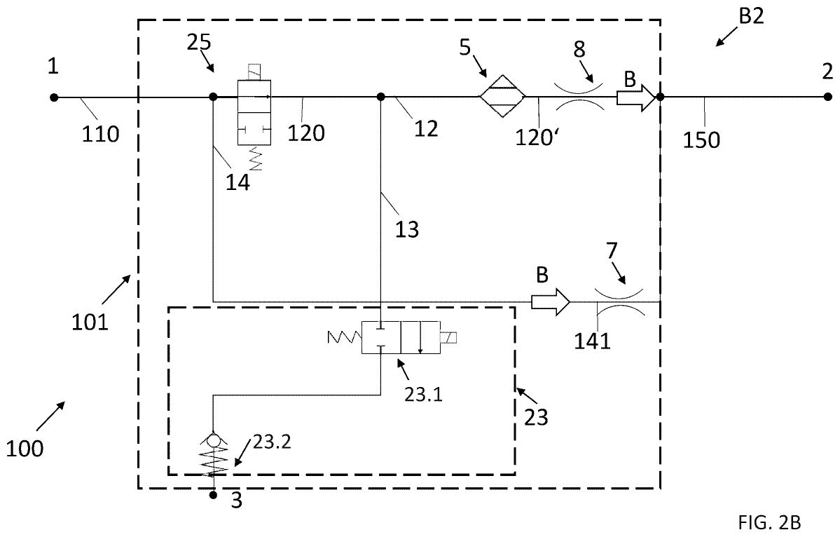

The compressed air supply system 1200 is connected to the compressed air generator 200 via a compressed air port 1 (see FIGS. 2A to 10). The compressed air supply unit 100 includes an air dryer 5, which is arranged in a pneumatic main line 12 (see FIG. 2A to FIG. 10), and a water separator 6, which is arranged between the air dryer 5 and the compressed air port 1 (see FIG. 2A to FIG. 10). The compressed air supply unit 100 moreover includes a pressure control module 101 which has a number of pneumatic valves (not shown) for distributing the pressure within the compressed air supply unit 100.

The functioning of the compressed air supply system 1200 and in particular of the compressed air supply unit 100 is explained below on the basis of preferred embodiments in FIG. 2A to FIG. 10.

In this connection, FIG. 2A and FIG. 2B show a first embodiment of the compressed air supply unit 100.

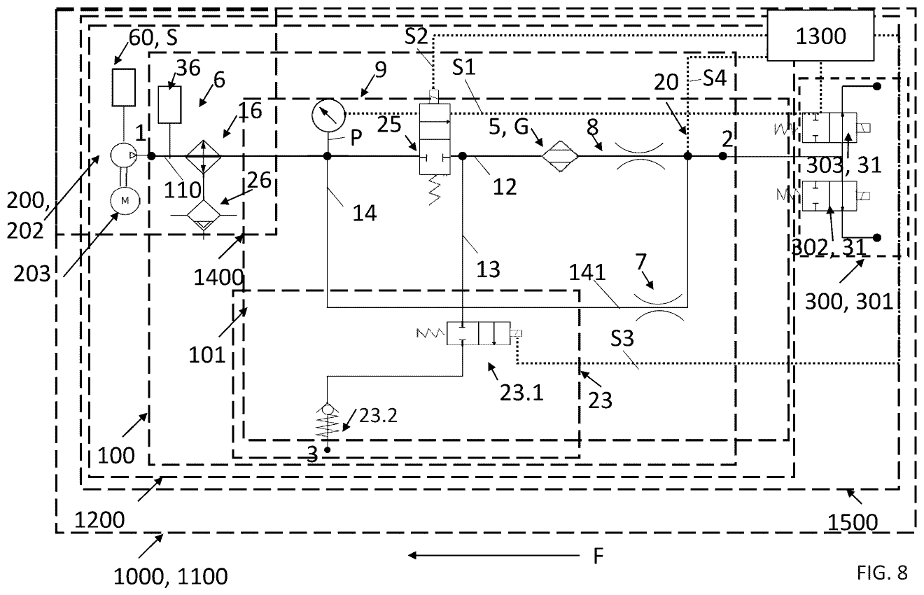

The compressed air supply unit 100 includes a compressed air port 1 for connection to a compressed air generator 200 (see FIG. 1) and a compressed air supply port 2 to which a compressed air consumer 300 can be connected (see FIG. 8 to FIG. 10). The compressed air port 1 is connected to the compressed air supply port 2 via a pneumatic main line 12. A venting line 13 preferably branches off from the pneumatic main line 12 to a venting port 3, which is configured for venting the pneumatic main line 12. The compressed air supply unit 100 moreover has an air dryer 5, which is arranged in the pneumatic main line 12. The air dryer 5 is configured for drying the compressed air 110 (see FIG. 2B) which is provided at the compressed air port 1 and conducted in a filling direction B through the pneumatic main line 12.

A venting valve arrangement 23 is preferably arranged in the venting line 13 with a venting valve 23.1, which is preferably an electrically controllable 2/2-way directional control valve. Furthermore, the venting valve arrangement 23 preferably includes a venting check valve 23.2 which is arranged downstream of the venting valve 23.1 in the direction of the venting line 3 and opens, preferably under pressure control, in the direction of the venting port. When the venting valve 23.1 is open, the venting check valve 23.2 thus preferably opens the venting line 13 as a result of the compressed air located in the venting line 13. At the same time, the venting check valve 23.2 prevents an ingress of moisture via the venting line 13. It should also be understood here that the venting line 13 can branch off at any position of the main line 12.

Advantageously, the compressed air supply unit 100 furthermore includes a main line throttle 8. The throttle 8 is preferably arranged downstream of the air dryer 5 in the filling direction B (see FIG. 2A). The main line throttle 8 is configured to throttle the compressed air 120′ dried by the air dryer 5 and to provide same at a defined supply pressure of preferably 5 bar at the compressed air supply port 2.

A branch line 14 furthermore branches off from the pneumatic main line 12 between the compressed air port 1 and the air dryer 5 and reconnects to the pneumatic main line 12 between the air dryer 5 and the compressed air supply port 2.

Furthermore, in the pneumatic main line 12 in the filling direction B downstream of the branching-off branch line 14, the compressed air supply unit 100 has a main line switching valve 25, which is configured to block the pneumatic main line 12 in a first operating mode B1 (see FIG. 2A) and to open the pneumatic main line 12 in a second operating mode B2 (see FIG. 2B).

A branch line throttle 7 is arranged In the branch line 14, the branch line throttle being configured to increase the flow resistance of the branch line 14 to a value higher than the flow resistance of the pneumatic main line. Thus, in the second operating mode, the compressed air preferably flows through the pneumatic main line 12 because of the lower flow resistance and, consequently, compressed air dried by the air dryer 5 passes predominantly to the compressed air supply port 2.

The compressed air supply unit 100 has the pressure control module 101 shown in FIG. 1. The pneumatic main line switching valve 25 and the venting valve 23.1 are assigned to the pressure control module 101.

FIG. 2A shows the compressed air supply unit 100 in the first operating mode B1. In the first operating state B1, the pneumatic main line switching valve 25 is configured to block the pneumatic main line 12. The pneumatic main line switching valve 25 is configured here as a normally closed 2/2-way directional control valve, so that the pneumatic main line switching valve 25, when de-energized, blocks the pneumatic main line 12 in the first operating state B1. The compressed air 110 provided at the compressed air port 1 is thus conducted exclusively via the branch line 14 in the filling direction B, that is, from the compressed air port 1 to the compressed air supply port 2.

The venting valve 23.1 is also configured as a normally closed 2/2-way directional control valve and, when de-energized, as shown in FIG. 2A, blocks the venting line 13 in the first operating mode B1.

FIG. 2B shows the compressed air supply unit 100 in the second operating mode B2. The pneumatic main line switching valve 25 is configured to open the pneumatic main line 12 in the filling direction B to enable the flow to pass through it, so that compressed air 110, 120 can be conducted from the compressed air port 1 to the air dryer 5 and dried by the latter. The dried compressed air 120′ is then supplied to the main line throttle 8 and provided as throttled compressed air, together with the compressed air 141 conducted through the branch line 14, at the compressed air supply port 2 as a joint compressed air flow 150.

The joint compressed air flow 150 which is provided at the compressed air supply port 2 has a portion of dried air 120′ from the pneumatic main line and a portion of moist air 141 from the branch line 14, so that the air in the joint compressed air flow 150 is at least partially dehumidified. The portion of the compressed air 120′ dried by the air dryer 5 depends, as described above, on the magnitude of the flow resistance caused by the branch line throttle 7.

The venting valve 23.1 is also configured in the second operating mode B2 to block the venting line 13.

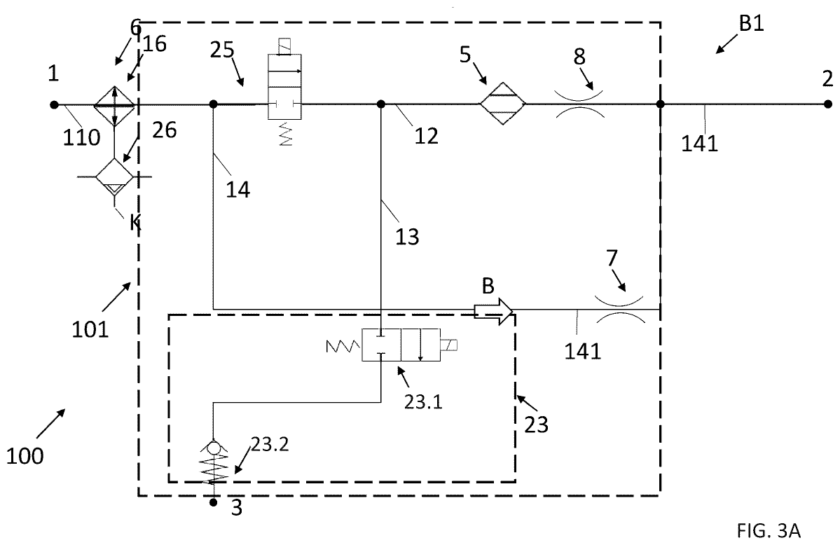

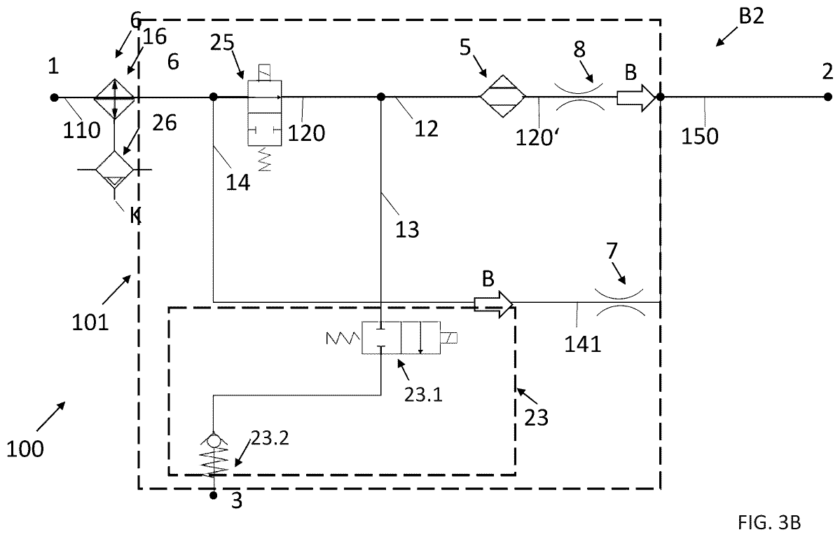

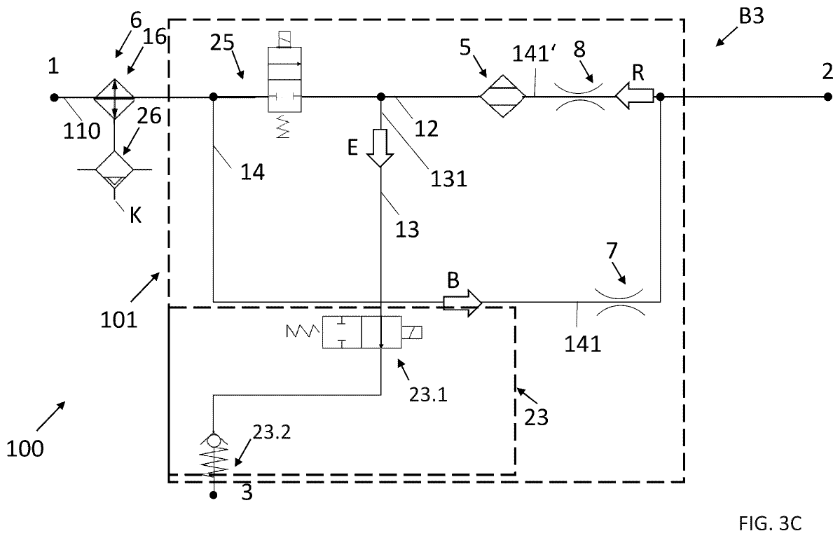

FIG. 3A to FIG. 3C show a second embodiment of the compressed air supply unit 100. The same components have identical reference signs here and, to avoid repetitions, only the differences of the first and the second embodiment of the compressed air supply unit 100 will be discussed.

The second embodiment of the compressed air supply unit 100 is developed by a water separator 6 which is arranged between the air dryer 5 and the compressed air port 1 (see FIG. 2A and FIG. 2B). The water separator 6 includes a condensation dryer 16 and a drain member 26, in particular in the form of a drain valve, which are configured to discharge at least a portion of the moisture of the compressed air 110 provided at the compressed air port 1. Thus, the saturation of the air dryer 5 is slowed down by the partially dehumidified compressed air 120 (see FIG. 3B) in the pneumatic main line 12.

FIG. 3A shows the compressed air supply unit 100 in a first operating mode B1. In the first operating mode, the pneumatic main line switching valve 25 blocks the pneumatic main line 12 in a known manner. The compressed air 141, which is at least partially dehumidified by the water separator 6 with the condensation dryer 16 and the separation valve 26, is thus conducted exclusively via the branch line 14 in the filling direction B to the compressed air supply port 2.

FIG. 3B shows the compressed air supply unit 100 in a second operating mode B2. In the present embodiment, the pneumatic main line switching valve 25 is energized in the second operating mode B2, so that it opens the pneumatic main line 12 in the filling direction B pneumatically to enable the flow to pass through it. The compressed air 120 which is partially dehumidified by the water separator 6 is thus conducted in the pneumatic main line 12 to the air dryer 5 and then throttled as dry compressed air 120′ by the main line throttle 8. Via the at least partial dehumidification of the compressed air 110 by the water separator 6, a lower saturation or slowed down saturation of the air dryer 5 also occurs in the second operating mode B2. Furthermore, some of the compressed air 141 which is partially dehumidified by the water separator 6 is conducted through the branch line 14 in the filling direction B.

The throttled dry compressed air 120′ from the pneumatic main line together with the compressed air 141 from the branch line forms a joint compressed air flow 150, which is provided at the compressed air supply port 2.

FIG. 3C shows the compressed air supply unit 100 in a third operating mode B3. In the third operating mode B3, the pneumatic main line switching valve 25 blocks the pneumatic main line 12, and the compressed air 141, which is partially dehumidified by the water separator 6, is conducted through the branch line 14 and returned through the pneumatic main line 12 in a return direction R counter to the filling direction B. In the pneumatic main line 12, the compressed air 141 is first of all expanded by the main line throttle 8 and, as expanded compressed air 141′, is used for regenerating the air dryer 5. The moist compressed air 131 which emerges again from the air dryer 5 is then conducted to the venting port 3 via the venting line 13. In the third operating mode B3, the venting valve 23.1 is configured to open the venting line 13 pneumatically to enable the flow to pass through it in the venting direction E.

The return direction within the meaning of the disclosure refers to the direction of the compressed air, which is conducted through a line, from the compressed air supply port counter to the filling direction.

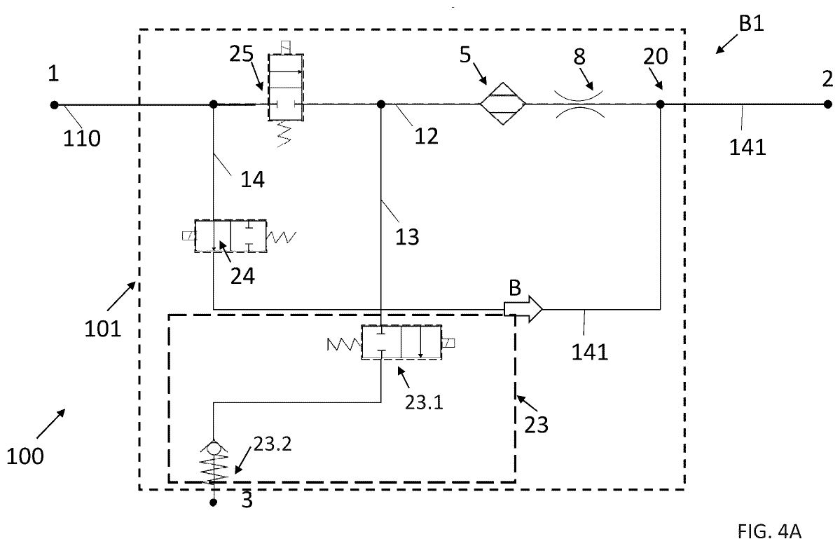

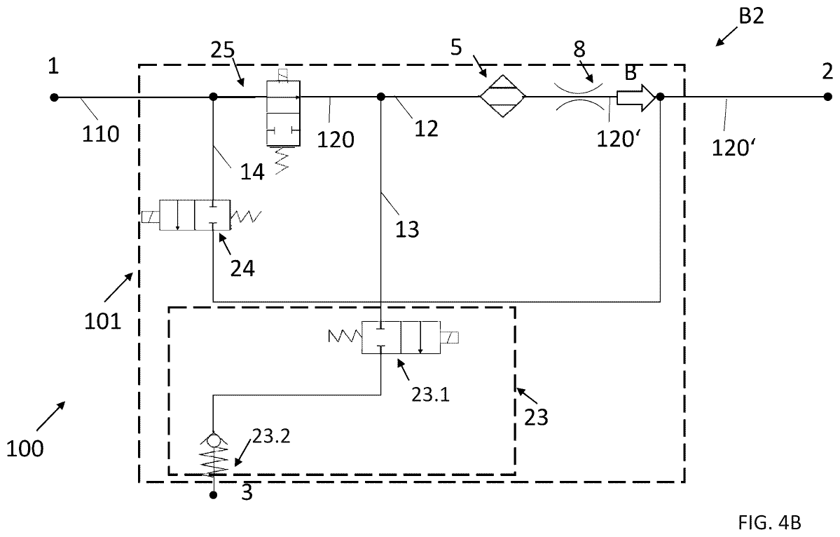

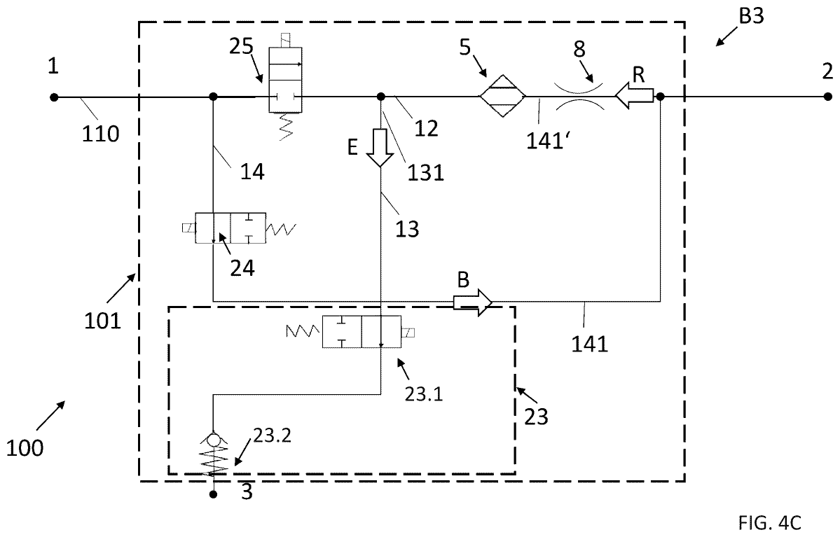

FIG. 4A to FIG. 4C show a third embodiment of the compressed air supply unit 100. Here, the same or similar components have identical reference signs, as in the preceding embodiments of the compressed air supply unit 100. In order to avoid repetitions, reference is made to the above description of the compressed air supply unit according to the first embodiment and only differences will be discussed below.

The third embodiment differs from the first embodiment shown in FIG. 2A to FIG. 2B by a branch line switching valve 24 which is arranged in the branch line 14 and is configured to open the branch line 14 in the first operating mode B1 pneumatically to enable the flow to pass through it and to block the branch line 14 in the second B2. The branch line switching valve 24 is preferably configured as a 2/2-way directional control valve. The branch line switching valve 24 is particularly preferably configured as a normally closed valve. Thus, as an alternative to the branch line throttle 7 (see FIG. 2A and FIG. 2B), provision of dried compressed air in the second operating mode can be ensured by the branch line switching valve 24.

FIG. 4A shows the compressed air supply unit 100 in a first operating mode B1. Partially dehumidified compressed air 141 from the water separator 6 continues to flow through the branch line switching valve 24 in the direction of the compressed air supply port 2.

FIG. 4B shows the compressed air supply unit 100 in the second operating mode B2. In the second operating mode B2, the advantage of the pneumatic branch line switching valve 24 arranged in the branch line becomes clear. The branch line switching valve 24 is configured to block the branch line 14 in the second operating mode B2. Thus, in the second operating mode B2, compressed air 120 from the water separator 6 passes exclusively via the pneumatic main line 12 to the compressed air supply port 2. In the pneumatic main line 12, the compressed air 120 is dried by the air dryer 5 and throttled by the main line throttle 8 and conducted further as dried, throttled compressed air 120′ in the filling direction B and provided at the compressed air supply port 2. Thus, only completely dried compressed air 120′ is now provided at the compressed air supply port 2. This is particularly advantageous at temperatures below freezing, especially at temperatures of −20° C. or lower, and ensures reliable and damage-free operation of the compressed air consumers (not shown) connected to the compressed air supply unit 100.

FIG. 4C shows the compressed air supply unit 100 in a third operating mode B3. The branch line switching valve 24 and the venting valve 23.1 are shown in the energized state and are thus configured for opening the branch line 14 or the venting line 13. The compressed air 141, which is conducted through the branch line 14, is returned in a return direction R through the pneumatic main line 12 counter to the filling direction B (see FIG. 4B). The compressed air 141 is first of all expanded by the main line throttle 8, with the relative humidity of the compressed air 141 decreasing. The expanded compressed air 141′ is then supplied to the air dryer 5 for regeneration and, finally, after at least a portion of the moisture of the drying substrate of the air dryer 5 is absorbed, is conducted as moist compressed air 131 in the venting direction E via the venting line 13 and the venting valve 23.1 in the direction of the venting port 3.

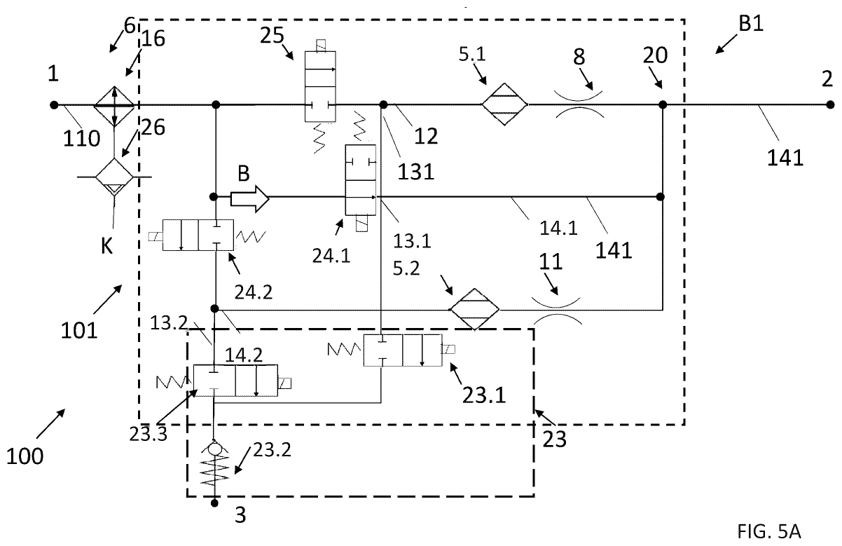

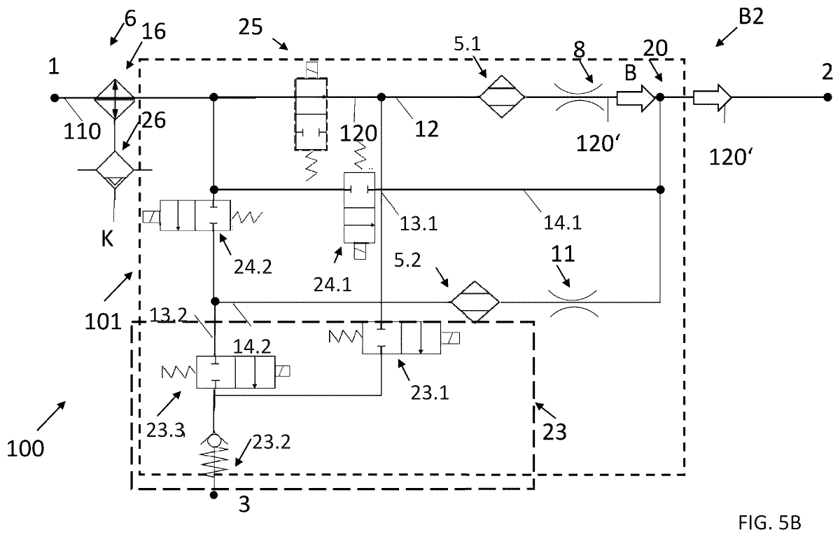

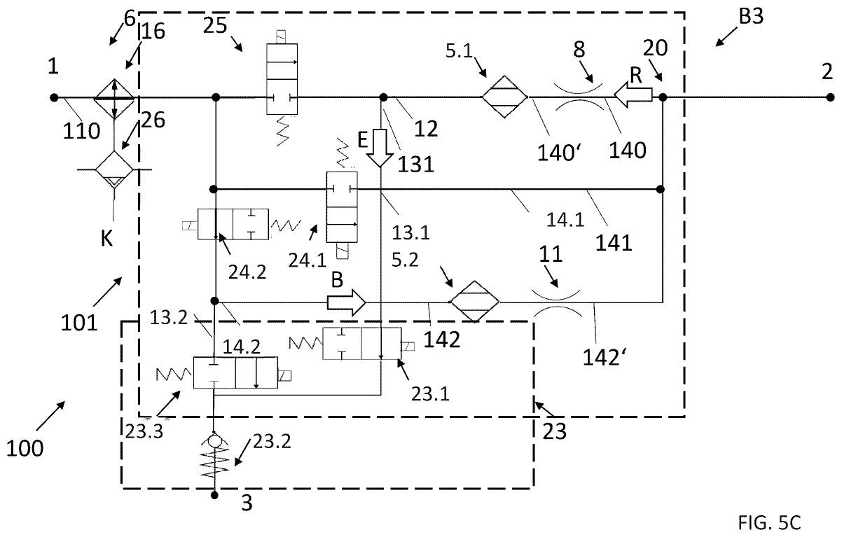

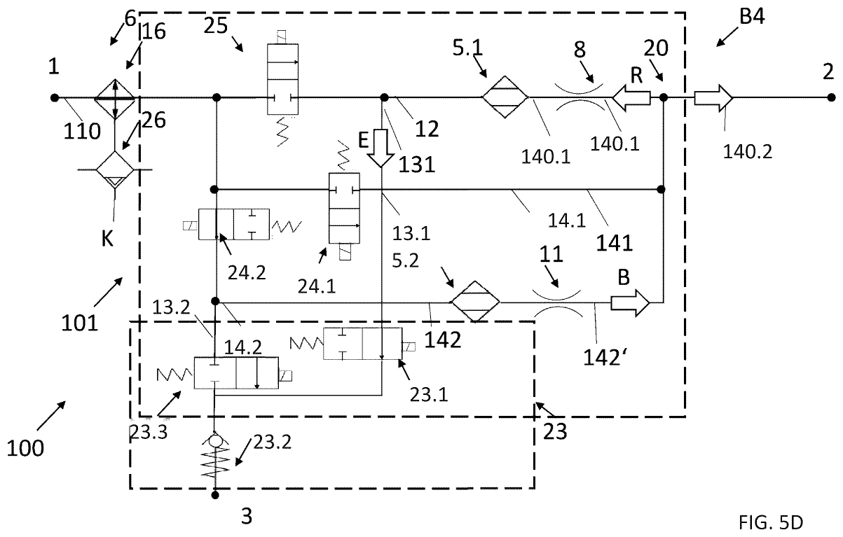

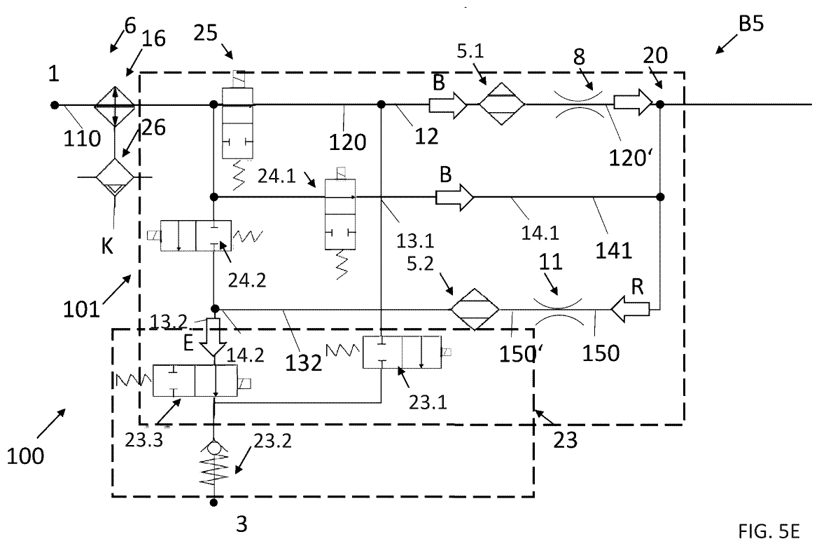

FIGS. 5A to 5E show the compressed air supply unit 100 according to a fourth embodiment. The same or similar components have identical reference signs here and, to avoid repetitions, reference is made to the description of the third embodiment of the compressed air supply unit and only differences with respect to the preceding embodiments will be discussed.

The fourth embodiment differs from the embodiment shown in FIG. 3A to FIG. 3C in that the branch line 14.1 is a first branch line 14.1 with a first pneumatic branch line switching valve 24.1. The compressed air supply unit 100 furthermore includes a second branch line 14.2 with a second pneumatic branch line switching valve 24.2. Furthermore, the air dryer 5.1 is a first air dryer, to which the main line throttle 8 is assigned, and the compressed air supply unit 100 furthermore includes a second air dryer 5.2 and preferably a branch line regeneration throttle 11, which is arranged between the second air dryer 5.2 and the compressed air supply port 2 and is assigned to the second air dryer 5.2. The second air dryer 5.2 and the branch line regeneration throttle 11 are arranged in the second branch line 14.2. Via the branch line regeneration throttle 11, compressed air which, for regenerating the second air dryer 5.2, is conducted through the second branch line counter to the filling direction, is expanded such that it can absorb more moisture.

The embodiment of the compressed air supply unit 100 according to FIG. 5A to FIG. 5E differs from the embodiment shown in FIG. 4A to FIG. 4C by a water separator 6 which is arranged between the air dryer 5 and the compressed air port 1 (see FIGS. 2A and 2B). The water separator 6 includes a condensation dryer 16 and a drain member 26, in particular in the form of a drain valve, which are configured to discharge at least a portion of the moisture of the compressed air 110 provided at the compressed air port 1. Thus, the saturation of the air dryer 5 is slowed down by the partially dehumidified compressed air 120 in the pneumatic main line 12.

Furthermore, the venting line 13.1 is a first venting line, and the venting valve 23.1 is a first venting valve, which is arranged in the first venting line 13.1. The first venting line 13.1 branches off from the pneumatic main line 12 between the water separator 6 and the first air dryer 5.1. Furthermore, the compressed air supply unit 100 includes a second venting line 13.2, in which a second venting valve 23.3 is arranged. The second venting line 13.2 branches off from the second branch line 14.2 between the second branch line switching valve 24.2 and the second air dryer 5.2. The venting check valve 23.2 is preferably connected downstream of the first and second venting valve 23.1, 23.3 in the direction of the venting port 3.

Furthermore, the compressed air supply unit 100 includes a pneumatic assembly 20, which is configured to allow a return of compressed air through the pneumatic main line 12 counter to the filling direction B in the third operating mode. Furthermore, the pneumatic assembly 20 is configured to selectively allow a supply of compressed air from the first branch line 14.1, the second branch line 14.2 and the pneumatic main line 12 in the direction of the compressed air supply port 2. Furthermore, the pneumatic assembly 20 is also configured for dividing the compressed air 140, which is provided by the branch lines 14.1, 14.2, into a first portion 140.1 for return through the pneumatic main line 12 and into a second portion 140.2 for provision at the compressed air supply port 2. Furthermore, the pneumatic assembly 20 is configured to allow compressed air to return through the second branch line 14.2 counter to the filling direction B.

The compressed air supply unit 100 has the pressure control module 101 shown in FIG. 1. The first and second branch line switching valves 24.1, 24.2, the pneumatic main line switching valve 25 and the first and second venting valves 23.1, 23.3 are assigned to the pressure control module 101.

FIG. 5A again shows a first operating mode B1 of the compressed air supply unit 100, in which the pneumatic main line switching valve 25 blocks the pneumatic main line 12. Furthermore, the second branch line switching valve 24.2 is configured to block the second branch line 14.2 in the first operating mode B1. Thus, compressed air 110 from the compressed air supply port 1 passes as compressed air 141 exclusively via the first branch line 14.1, which is released by the first branch line switching valve 24.1 in the first operating mode B1, to the compressed air supply port 2. For this purpose, the normally closed 2/2-way directional control valve, which is provided as the first branch line switching valve 24.1, is energized. Thus, in the first operating mode B1, neither the first air dryer 5.1 and the second air dryer 5.2 are actively used and are thus “conserved” and the compressed air 141 is provided exclusively via the first branch line 14.1. The moist compressed air 141 can be used especially when the temperatures are far above freezing.

FIG. 5B shows the compressed air supply unit 100 in the second operating mode B2. In the second operating mode B2, the pneumatic main line switching valve 25 is configured to open the main line 12 pneumatically to enable the flow to pass through it. In the second operating mode B2, the first and the second branch line switching valves 24.1, 24.2 are configured to block the respective branch line 14.1, 14.2. Compressed air 110 from the compressed air port 110 thus passes as dried and throttled compressed air 120′ exclusively via the pneumatic main line 12 to the compressed air supply port 2. This throttled and dried compressed air 120′enables safe operation, even at temperatures below freezing, of compressed air consumers (not shown), which are connectable to the compressed air supply unit 100.

FIG. 5C shows the compressed air supply unit 100 in a third operating mode B3. In the third operating mode B3, the first and/or the second branch line switching valve 24.1, 24.2 is/are configured to open the respective branch line 14.1, 14.2 pneumatically to enable the flow to pass through it. The pneumatic main line switching valve 25 is configured to block the pneumatic main line 12. In a first variant of the third operating mode B3, the first branch line switching valve 24.1 is configured to open the first branch line 14.1 pneumatically to enable the flow to pass through it, so that compressed air 141, which is pre-dried by the water separator, is returned into the pneumatic main line 12 counter to the filling direction B. In this case, the second air dryer 5.2 continues to be conserved. In a second variant of the third operating mode B3, the second branch line switching valve 24.2 is configured to open the second branch line 14.2 pneumatically to enable the flow to pass through it, so that compressed air 142, which is pre-dried by the water separator 16 and subsequently dried by the air dryer 5.2, is returned into the pneumatic main line 12 counter to the filling direction B. In this case, a higher degree of efficiency is achieved in the regeneration of the first air dryer 5.1. In a third variant of the third operating mode B3, both branch line switching valves 14.1, 14.2 can also be opened pneumatically to enable the flow to pass through them.

Furthermore, the first venting valve 23.1 is configured to open the first venting line 13.1 pneumatically to enable the flow to pass through it and the second venting valve 23.3 is configured to block the second venting line 13.2. The pneumatic assembly 20 is configured to allow compressed air to return from the first and second branch line 14.1, 14.2 counter to the filling direction B-that is, in a return direction R-through the pneumatic main line 12. The compressed air 141, 142 from the first and second branch line 14.1, 14.2 is returned into the pneumatic main line 12 as a joint compressed air flow 140 and is expanded by the main line throttle 8. The expanded compressed air 140′is then conducted through the first air dryer 5.1 for regeneration of the latter and is then discharged as moist compressed air 131 in the venting direction E via the first venting line 13.1.

FIG. 5D shows a fourth operating mode B4, in which, in contrast to the third operating mode, the joint compressed air flow 140 of the first branch line 14.1 and of the second branch line 14.2 is returned not exclusively into the pneumatic main line 12, but rather only a first portion 140.1 is returned and a second portion 140.2 is provided at the compressed air supply port 2. Thus, the first air dryer 5.1 can be regenerated and at the same time a compressed air consumer (not shown) can be supplied with compressed air 140.2.

FIG. 5E shows a fifth operating mode B5 of the compressed air supply unit 100, in which a joint compressed air flow 150 from the pneumatic main line 12 and/or the first branch line 14.1 is returned into the second branch line 14.2 in order to regenerate the air dryer 5.2.

In a first variant of the fifth operating mode B5 (not shown in FIG. 5E), the first branch line switching valve 24.1 is configured to open the first branch line 14.1 pneumatically to enable the flow to pass through it, so that compressed air 141 pre-dried by the water separator 6 is returned counter to the filling direction B into the second branch line 14.2 where it is firstly expanded by the branch line throttle 11. The expanded compressed air 141′ is then conducted through the second air dryer 5.2 to bind a portion of the moisture of the drying substrate of the second air dryer 5.2. Subsequently, moist compressed air 132 is conducted to the venting port 3 via the second venting line 13.2. In this case, the first air dryer 5.1 continues to be conserved.

In a second variant of the fifth operating mode B5 (not shown in FIG. 5E), the main line switching valve 25 is configured to open the pneumatic main line 12 pneumatically to enable the flow to pass through it, so that compressed air 120 pre-dried by the water separator 16 and compressed air 120′ subsequently dried by the air dryer 5.1 are returned from the pneumatic main line 12 counter to the filling direction B into the second branch line 14.2 where they are firstly expanded by the branch line throttle 11. The expanded compressed air 120′ is then conducted through the second air dryer 5.2 to bind a portion of the moisture of the drying substrate of the second air dryer 5.2. Subsequently, moist compressed air 132 is conducted to the venting port 3 via the second venting line 13.2. In this case, a higher degree of efficiency in the regeneration of the second air dryer 5.2 is achieved.

In a third variant of the fifth operating mode B5, which is shown in FIG. 5E, the first branch line switching valve 24.1 and the main line switching valve 25 can also be opened pneumatically to enable the flow to pass through them. In the process, the compressed air 120′ from the pneumatic main line 12 and the compressed air 141 from the first branch line 14.1 form a joint compressed air flow 150, which is returned in a return direction R through the second branch line 14.2, where it is firstly expanded by the second branch line throttle 11. The expanded compressed air 150′ is then conducted through the second air dryer 5.2 to bind a portion of the moisture of the drying substrate of the second air dryer 5.2. Subsequently, moist compressed air 132 is conducted to the venting port 3 via the second venting line 13.2. For this purpose, the second venting valve 23.3 is shown in the energized state and is configured to release the second venting line 13.2.

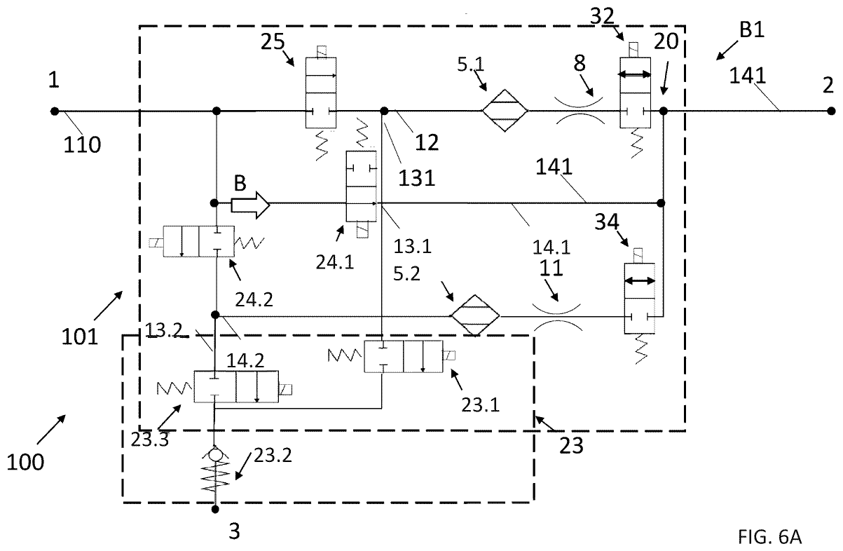

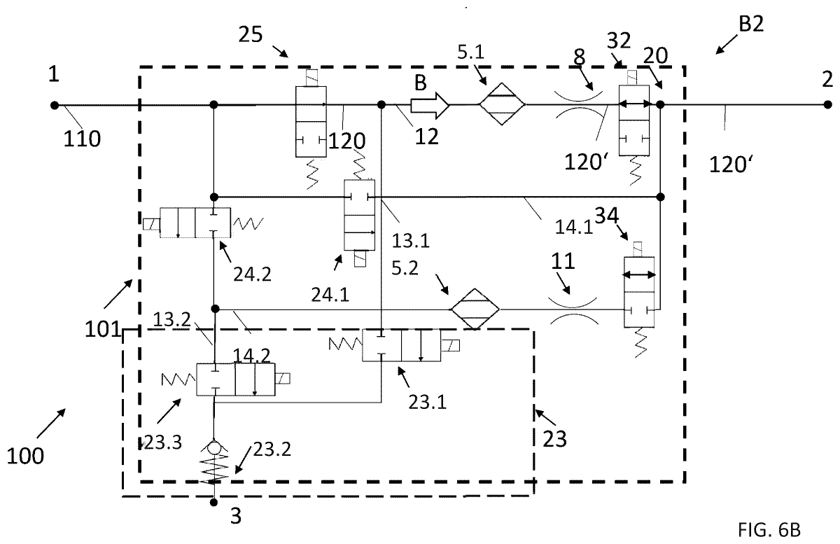

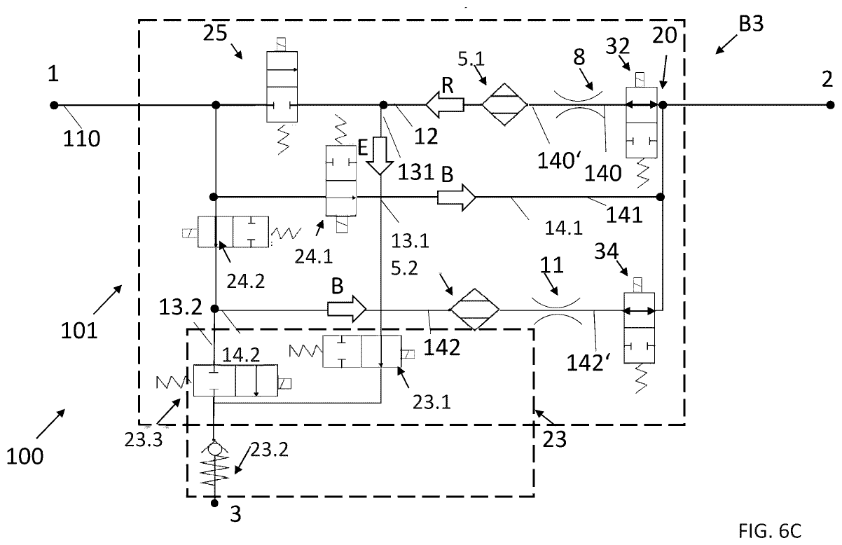

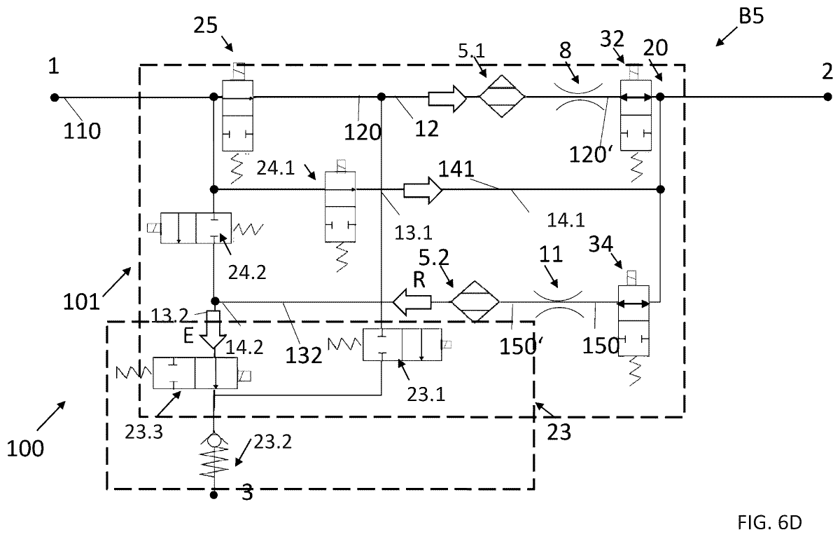

FIG. 6A to FIG. 6D show a fifth embodiment of the compressed air supply unit 100. The same or similar components have identical reference signs here and, to avoid repetitions, reference is made to the description of the first to fourth embodiments of the compressed air supply unit and only differences with respect to the preceding embodiments will be discussed.

In the fifth embodiment, a first shut-off valve 12, in particular as part of the pneumatic assembly 2, is arranged in the pneumatic main line 32 between the compressed air supply port 20 and the first air dryer 5.1. The first shut-off valve 32 is configured to cooperate with the pneumatic main line switching valve 25 and, in the event that the pneumatic main line switching valve 25 blocks the pneumatic main line 12, to block a return of compressed air through the pneumatic main line 12 in the return direction R. Furthermore, a second shut-off valve 34, in particular as part of the pneumatic assembly 20, is arranged in the second branch line 14.2 between the compressed air supply port 2 and the second air dryer 5.2. The second shut-off valve 34 is configured to cooperate with the second branch line switching valve 24.2 and, in the event that the second branch line switching valve 24.2 blocks the second branch line 14.2, to block a return of compressed air through the second branch line 14.2 in the return direction R.

In the first operating mode B1, which is shown in FIG. 6A, the first shut-off valve 32 cooperates with the pneumatic main line switching valve 25 in such a way that the shut-off valve 32 blocks the pneumatic main line. Thus, in the first operating mode B1, moist compressed air from the first branch line 14.1 cannot penetrate into the pneumatic main line 12 and thus result in the air dryer 5.1 absorbing water. In a corresponding manner, in the first operating mode B1, the second shut-off valve 34 is configured to block the second branch line 14.2. Thus, no compressed air from the first branch line 14.1 can pass counter to the filling direction B into the second branch line 14.2 and thus to the second air dryer 5.2.

As shown in FIG. 6B, the first shut-off valve 32 opens the pneumatic main line 12 in the second operating mode B2, in which the pneumatic main line switching valve 25 also opens the pneumatic main line 12 pneumatically to enable the flow to pass through it. Especially since the second air dryer 5.2 is not used in the second operating mode B2, the second shut-off valve 34 blocks the second branch line 14.2, so that no compressed air can pass in the return direction R counter to the filling direction B to the second air dryer 5.2. Shut-off valves of this type also allow the degree of saturation of the first and second air dryers 5.1, 5.2 to be better calculated.

Furthermore, the first shut-off valve 32 is configured, in the third operating mode B3, as shown in FIG. 6C, to open the pneumatic main line 12 pneumatically to enable the flow to pass through it, so that compressed air 140 for the regeneration is conducted in the return direction R through the pneumatic main line 12 to the first air dryer 5.1 and can be discharged again via the venting port 3.

As shown in FIG. 6D, in the fifth operating mode, the first switching valve 32 is configured to open the pneumatic main line and the second shut-off valve 34 is configured to open the second branch line 14.2 pneumatically to enable the flow to pass through it. For the regeneration of the second air dryer 5.2, compressed air from the pneumatic main line 2 and/or from the first branch line 14.1 can thus be returned as a joint compressed air flow 150 in the return direction R.

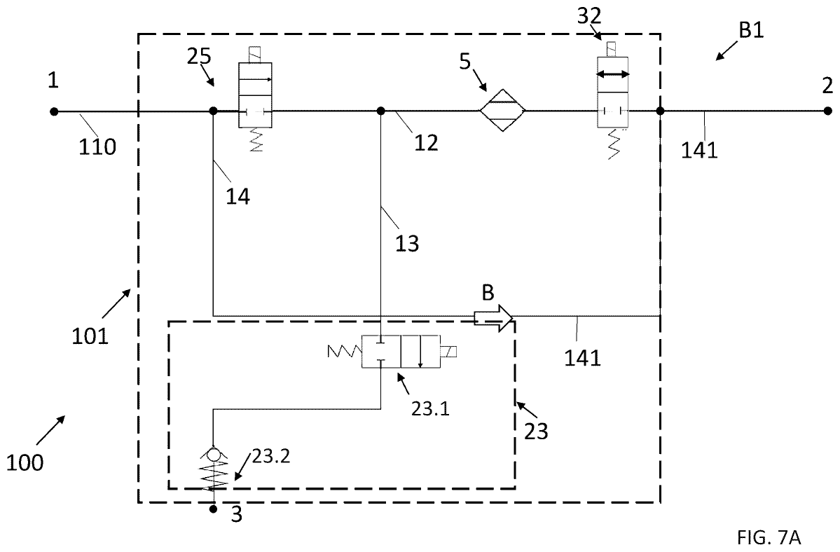

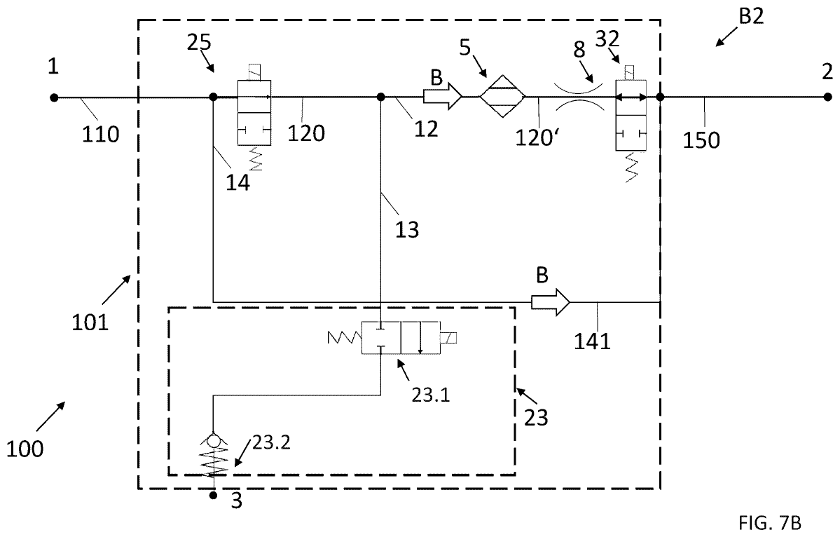

FIG. 7A to FIG. 7B show a sixth embodiment of the compressed air supply unit 100. Here, the same or similar components have identical reference signs and, in order to avoid repetitions, reference is made to the description of the first embodiment of the compressed air supply unit and only differences with respect to embodiments preceding it will be discussed. In this case, the compressed air supply unit 100 does not have a branch line throttle 7, which is shown in FIG. 2A and FIG. 2B. The compressed air supply unit 100 here 1 has a shut-off valve 32, in particular arranged as part of the pneumatic assembly 20. The shut-off valve 32 is configured to cooperate with the pneumatic main line switching valve 25 and, in the event that the pneumatic main line switching valve 25 blocks the pneumatic main line 12, to block a return of compressed air through the pneumatic main line 12 in the return direction R.

FIG. 8 shows a vehicle 1000, in particular a passenger car 1100. The passenger car 1100 includes a compressed air supply system 1200 as well as an electronic control device 1300 and a compressed air consumer 300, which in the present case includes a sensor cleaning device 301. The compressed air supply system 1200 and the sensor cleaning device 301 form a pneumatic system 1500.

The compressed air supply system 1200 includes a compressed air supply unit 100 and a compressed air generator 200, which is connected to the compressed air supply unit 100 via a compressed air port 1. The compressed air generator 200 here includes a compressor 202 with an electric motor 203.

The compressed air supply unit 100 is shown here in a sixth embodiment. The same or similar components again have identical reference signs, as in the preceding embodiments, and, in order to avoid repetitions, only differences in particular with respect to the second embodiment will be discussed (see FIG. 3A to FIG. 3C).

In this case, in addition to the condensation dryer 16 and the drain member 26, the water separator 6 furthermore includes a ventilation device 36. The ventilation device 36 is arranged between the compressed air port 1 and the condensation dryer 16 and increases the degree of cooling of the compressed air in the condensation dryer 16. The water separator 6 with the condensation dryer 16, the drain member 26 and the ventilation device 36 is preferably arranged in a front part 1400 of the vehicle 1000 in the direction of travel F. This means that, in addition, the head wind occurring during operation can be used to cool the compressed air, which is compressed by the compressor 202.

Furthermore, according to the sixth embodiment shown, the compressed air supply unit 100 includes a pressure sensor 9, which is arranged in the pneumatic main line 12 between the water separator 6 and the air dryer 5. The pressure sensor 9 is configured to detect a pressure P in the pneumatic main line 12, that is, the compressed air 110 which is provided at the compressed air port 1 or the compressed air 120 which is partially dehumidified by the water separator 6. The pressure sensor 9 is signal-conductingly connected via a first signal line S1 to the control device 1300, which is thus configured for monitoring the pressure P.

The control device 1300 is furthermore signal-conductingly connected via a second signal line S2 to the switching valve 24 and signal-conductingly connected via a third signal line S3 to the venting valve 23.1.

The control device 1300 is configured to actuate the main line switching valve 25 for selectively releasing the main line 12 or the venting valve 23.1 for selectively releasing the venting line 13. Furthermore, the control device 1300 is connected via a fourth signal line S4 to the pneumatic assembly 20, which has been described with respect to the fourth and fifth embodiments. The control device 1300 is configured to control the first portion 140.1 (see FIG. 6C) of the compressed air and the second portion of the compressed air 140.2 (see FIG. 6C) by actuation of the pneumatic assembly 20.

The control device 1300 is configured to actuate the compressed air generator 200 depending on the detected sensor signal of the pressure sensor 9. Furthermore, the control device 1300 can actuate the main line switching valve 25 and the venting valve 23.1 to release compressed air in the pneumatic main line—at least in the filling direction B upstream of the main line throttle 8.

The signal lines S1, S2, S3, S4 can be wired or wireless.

The compressed air supply unit 100 has the pressure control module 101 shown in FIG. 1. The pneumatic main line switching valve 25 and the venting valve 23.1 and the pressure sensor 9 are assigned to the pressure control module 101.

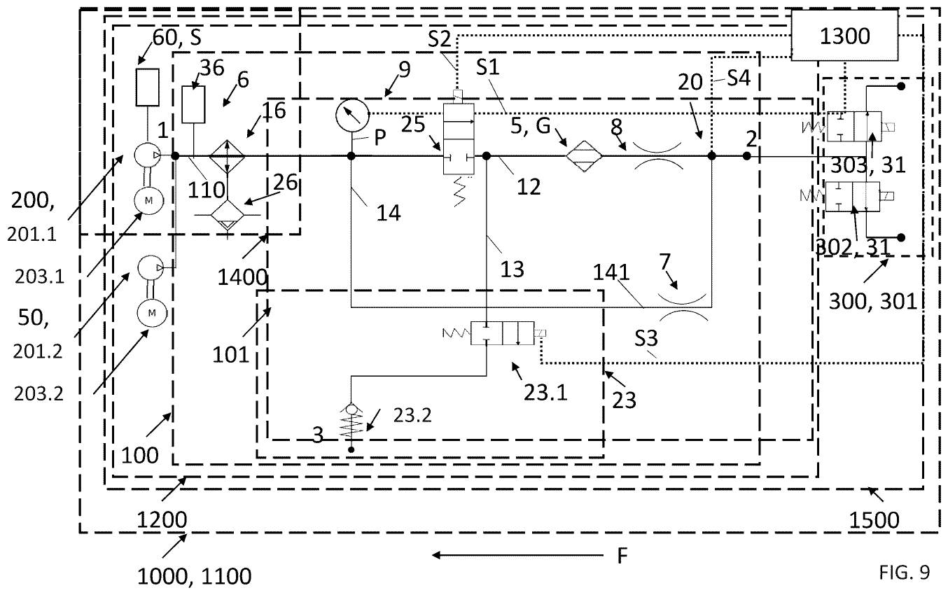

FIG. 9 shows a second embodiment of the vehicle 1000. In order to avoid repetitions, reference is made to the description of the vehicle 1000 according to the first embodiment in FIG. 8 and only differences will be discussed. The same or similar components have identical references here. The compressed air supply system 1200 and the sensor cleaning device 301 form a pneumatic system 1500.

The second embodiment of the vehicle 1000 as shown according to FIG. 9 differs from the first embodiment in that the compressing device 201.1 is configured as a first compressing device 201.1 with a first electric motor 203.1. Furthermore, the vehicle 1000 and the compressed air supply system 1200 include an additional compressed air source 50 with a second compressing device 201.2 and a second electric motor 203.2.

The control device 1300 is preferably configured to selectively add the compressed air source 50, in addition to adding and controlling the compressed air generator 200. Both the compressed air generator 200 and the compressed air source 50 are connected to the compressed air port 1 for supplying the compressed air supply unit 100 with compressed air 110.

According to various embodiments, in the embodiments according to FIGS. 8, 9 and 10, the compressed air supply system 1200 furthermore includes a temperature sensor 60 for monitoring the temperature of the compressed air generator 200, the temperature sensor 60 being signal-conductingly connected to the control device 1300 and being configured to provide sensor signals S.

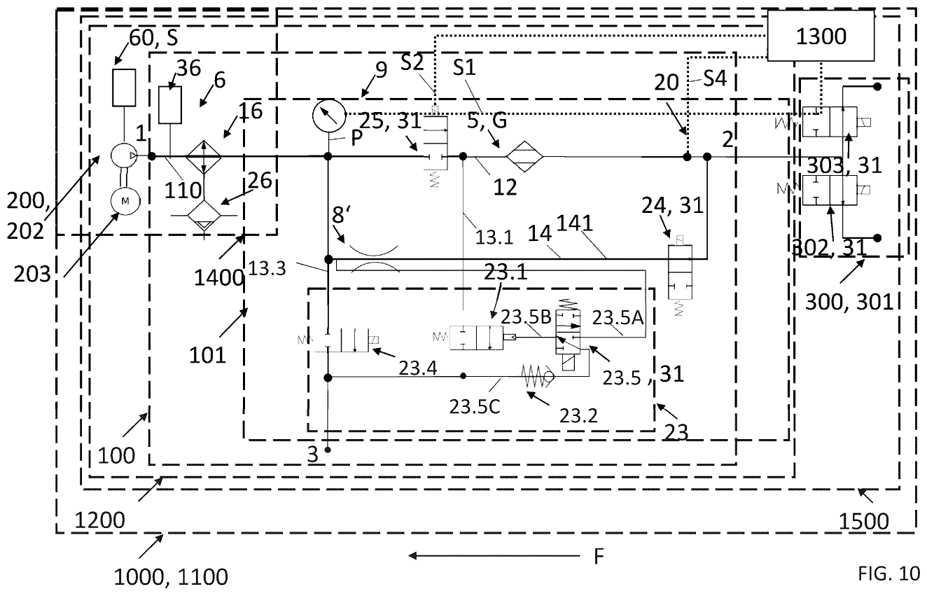

FIG. 10 shows a third embodiment of the vehicle 1000. In order to avoid repetitions, reference is made to the description of the vehicle 1000 according to the first embodiment in FIG. 8 and only differences will be discussed. The same or similar components have identical references here.

The third embodiment of the vehicle 1000 as shown according to FIG. 10 differs from the first embodiment in that the main line throttle 8, instead of being arranged in the pneumatic main line 12, is now arranged as a shifted main line throttle 8′ in the branch line 14 upstream of the branch line switching valve 24. The shifted main line throttle 8′ expands the compressed air 141, which is provided at the compressed air port 1, at the beginning of the branch line 14. This firstly allows the provision of compressed air at the compressed air port 1 at a pressure above the supply pressure of in particular 5 bar to be provided, as a result of which more effective condensation drying by the condensation dryer 16 is achieved. Furthermore, the throttling of the compressed air to preferably 5 bar leads to a reduction of the relative humidity.

Furthermore, a branch line switching valve 24 is arranged in the branch line 14, as described with respect to FIG. 4A to FIG. 4C.

The venting line arrangement 23 has a control valve 23.5 in the form of a 2/2-way solenoid directional control valve 31. Furthermore, the venting valve 23.1 is configured as a pneumatically actuable venting valve 23.1. The control valve 23.5 can be actuated via electrical control signals in the form of a voltage and/or current signal. Upon actuation, the control valve 23.5 can be transferred from a normally closed position (as shown here) into a pneumatically open position (not shown), in which a pressure derived via a pneumatic control line 23.5A from the branch line 14 in the filling direction B upstream of the shifted main line throttle 8′ is transmitted via a bypass 23.5B for the pneumatic control of the controllable venting valve 23.1. Alternatively, pressure can also be derived from the pneumatic main line 12 (not shown).

When closed, the control valve 23.5 disconnects the control line 23.5A and is pneumatically connected to the venting port 3 via a further pneumatic line 23.5C.

The venting line 13.1 here is a first venting line 13.1 and the compressed air supply unit 100 furthermore includes a compressor venting line 13.3. The compressor venting line 13.3 branches off from the pneumatic main line 12 upstream of the main line switching valve 25 in the filling direction B. The venting valve arrangement 23 has a compressor venting valve 23.4 in the compressor venting line 13.3. Via the compressor venting line 13.3, the line volume between the compressed air generator 200, here preferably a compressor 202, and the branch line switching valve 24 and the main line switching valve 25 can be vented. The starting resistance for the compressor 202 is thus reduced.

The venting valve 23.1, the compressor venting valve 23.4 and the branch line switching valve 24 and the main line switching valve 25 are configured here as solenoid directional control valves 31, in particular normally closed solenoid directional control valves 31.

The compressed air consumer 300, which here is a sensor cleaning device 301, furthermore includes a first nozzle valve 302 and a second nozzle valve 303. The nozzle valves 302, 303 are also solenoid directional control valves 31, in particular normally closed solenoid directional control valves 31.

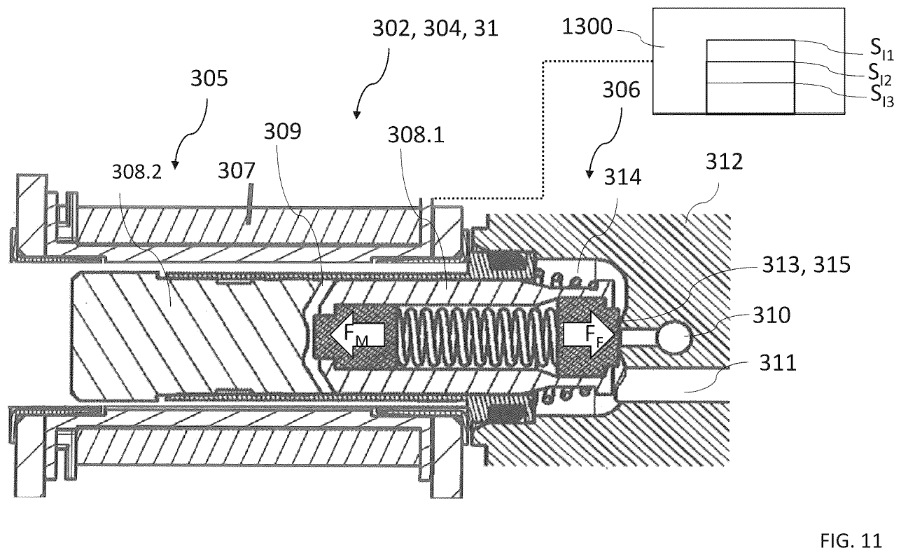

Such a solenoid directional valve is shown by way of example in FIG. 11 with reference to one possible configuration of a nozzle valve 302. The nozzle valve 302 is a normally closed 2/2-way directional control valve 304. The nozzle valve 302 includes a magnetic part 305 and a pneumatic part 306. The magnetic part 305 has an electric coil 307, an armature 308.1, which is actuable magnetically and under the influence of a spring force, and a fixed magnetizable core 308.2. An air gap 309 which defines the possible stroke of the armature 308.1 is formed between the armature 308.1 and the core 308.2.

The pneumatic part 306 includes a first compressed air passage 310 and a second compressed air passage 311. The pneumatic part 306 furthermore includes a valve punch part 312, which has an impact surface 313 facing in the direction of the armature 308.1.

The nozzle valve 302 furthermore includes a valve spring 314, which is configured to apply a spring force F_{F} to the armature 308.1 in the direction of the valve punch part 312, in particular the impact surface 313. When the nozzle valve 302 is open, the armature 308.1 is spaced from a valve seat 315 of the pneumatic part 306.

The armature 308.1 is movably mounted in the magnetic part 305 and the pneumatic part 306. By energizing of the electric coil 307, the latter generates a magnetic field with a magnetic force F_{M}. The resulting magnetic field generates a magnetic pole at the core 308.2, which attracts the armature 308.1 and moves the latter away from the valve seat 315 counter to the spring force F_{F} of the valve spring 314, so that the first compressed air passage 310 and the second compressed air passage 311 are fluid-conductively connected. The magnitude of the magnetic force F_{M} depends on the applied control current S_{I} which is provided by the control device 1300. The opening control current S_{I1} required for opening the nozzle valve 302 is greater than the holding control current S_{I2} required for holding the nozzle valve 302 in the open position. The magnitude of the force that a magnetic field induced by the coil 307 applies to the armature 308.1 at a constant current depends on the distance of the armature 308.1 relative to the magnetic field, that is, on the size of the air gap 309 between the armature 308.1 and the core 308.2. At a larger distance, a weaker magnetic field is therefore in effect. In the closed position, the armature 308.1 is initially at a greater distance from the magnetic field, so that an increased current, namely an opening control current S_{I1}, is provided. The opening control current S_{I1} required for opening the nozzle valve 302 refers to the current which is required for reducing the distance of the armature 308.1 from the core 308.2 and thus for reducing the air gap 309. As soon as the armature 308.1 moves to an open position, its distance from the magnetic field is reduced and a lower holding control current S_{I2} is sufficient for holding the armature 308.1 in this position. The control device 1300 is moreover preferably configured to apply a heating control current S_{I3} to the nozzle valve 302, the heating control current being smaller than the opening control current S_{I1}, in particular also smaller than the holding control current S_{I2}, such that the nozzle valve 302 is heated in the closed state by the generated magnetic field.

The control device 1300 shown in the FIG. 8 to FIG. 10 is configured to open the compressor venting valve 23.4 and the branch line switching valve 24, the main line switching valve 25 and the nozzle valves 302, 303 and to provide a control current S_{I} at the level of the opening control current S_{I3} (see FIG. 10). Furthermore, the control device 1300 is also configured to apply a heating control current S_{I3} to one, a plurality or all of these valves.

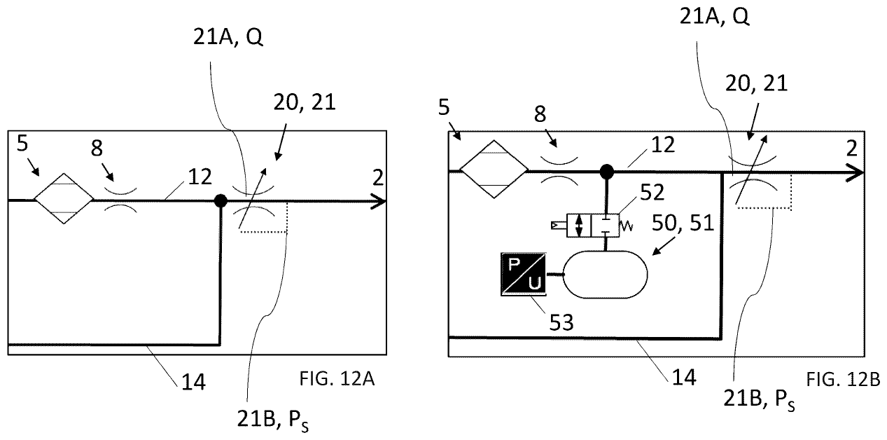

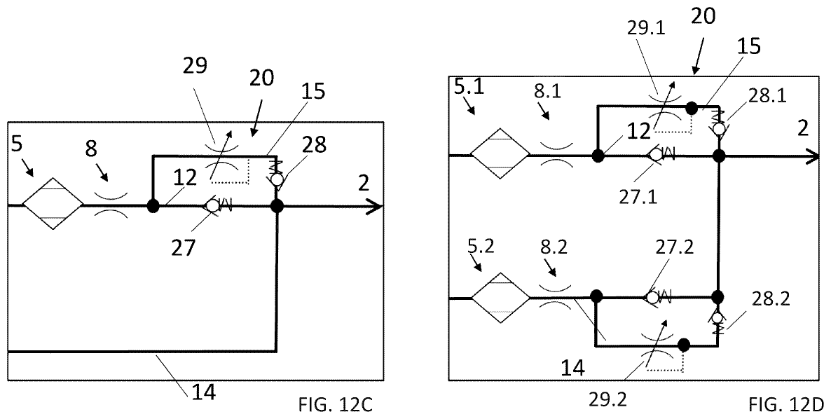

FIG. 12A to FIG. 12D show a detail of the compressed air supply system 1200 according to FIGS. 8, 9 and 10, with various embodiments of the pneumatic assembly 20 being shown in detail. In order to avoid repetitions and to explain the functioning of the pneumatic assembly 20, reference is therefore made to the description of FIGS. 8, 9 and 10.

The pneumatic assembly 20 according to FIG. 12A includes a throttle valve 21, which is configured to throttle compressed air conducted in the filling direction B to the compressed air supply port 2. The throttle valve 21 has a variable flow cross section Q and is connected in terms of control, that is, signal-conductingly, to the control device 1300. The throttle valve 21 is configured to throttle the pressure in the pneumatic main line 12 to a supply pressure to be provided of, in particular, 5 bar by a change in the flow cross section Q. The throttle valve 21 has a throttle point 21A with a variable flow cross section Q, the throttle valve 21 having a control pressure line 21B for conducting a control pressure P_{S} and being configured to regulate the flow cross section Q depending on the control pressure P_{S}.

Analogously to the embodiment shown in FIG. 12A, the pneumatic assembly 20 according to FIG. 12B is a throttle valve 21. Furthermore, the compressed air supply system 1200 includes an additional compressed air source 50 in addition to the compressed air generator 200, which is in the form of a compressor 202 in FIG. 8. The compressed air source 50 includes a reservoir 51 for storing compressed air, the reservoir being connected to the pneumatic main line 12 via a reservoir switching valve 52. The compressed air source 50 is configured to be connected to the pneumatic main line 12 as required by actuation of the reservoir switching valve 52. The control device 1300 (see FIGS. 8, 9 and 10) is signal-conductingly connected to a reservoir pressure sensor 53 and is configured for actuating the reservoir switching valve 52. By actuation of the reservoir switching valve 52, a defined amount of compressed air can be directed into the pneumatic main line 12, with the control device regulating the amount of pressure via the signals of the reservoir pressure sensor 53. The required compressed air is therefore immediately available.

The pneumatic assembly 20 according to FIG. 12C includes a pair of check valves 27, 28 which open in opposite directions and are connected in parallel in terms of flow, the pair being arranged between the air dryer 5 and the compressed air supply port 2.

The pair of check valves 27, 28 includes a first check valve 27 which opens in the filling direction B and is arranged in the pneumatic main line 12, and, furthermore, a second check valve 28 opening in the return direction R. The second check valve 28 is arranged in a bypass line 15, which forms a bypass around the first check valve 27. The pneumatic assembly 20 furthermore includes a return throttle valve 29 which is arranged downstream of the second check valve 28 in the return direction R (see FIG. 3C).

The pneumatic assembly 20 according to FIG. 12D is configured for use with compressed air supply units, such as those shown in FIGS. 5A-5E or FIGS. 6A-6D, that is, for compressed air supply units having two air dryers 5.1, 5.2. A first pair of check valves 27.1, 28.1 which open in opposite directions and are connected in parallel in terms of flow and have a corresponding recirculation throttle valve 29.1, as has been described with respect to the embodiment according to FIG. 1C, is assigned to the first air dryer 5.1 and arranged between the first air dryer 5.1 and the compressed air port 2.

A second pair of check valves 27.2, 28.2 which open in opposite directions and are connected in parallel in terms of flow and have a corresponding second recirculation throttle valve 29.2, as has been described with respect to the embodiment according to FIG. 12D, is assigned to the second air dryer 5.2 and arranged between the second air dryer 5.2 and the compressed air port 2.

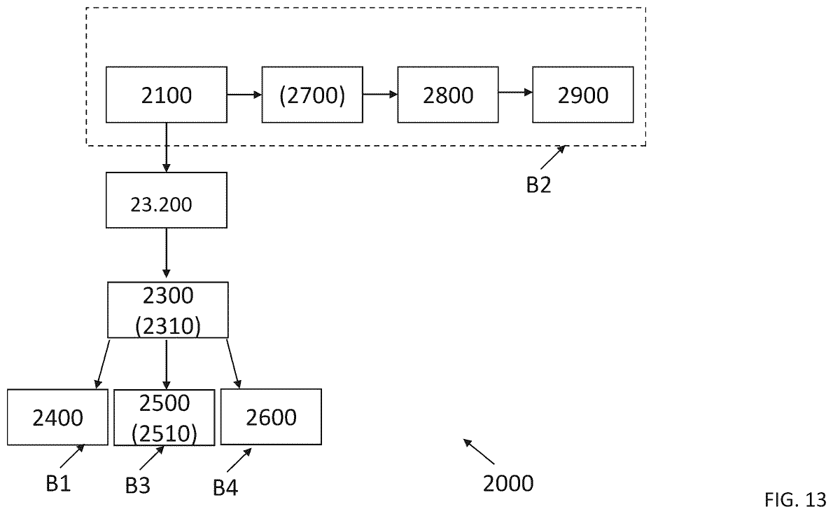

FIG. 13 shows a method 2000 for operating a compressed air supply system 1200 (see FIGS. 8, 9 and 10), the method 2000 including, in a first step 2100, the provision of compressed air 110 at a compressed air port 1, which is connected via a pneumatic main line 12 to a compressed air supply port 2.

In a first operating mode B1 or third operating mode B3 or fourth operating mode B4, the method 2000 furthermore includes, in a second step 2200, blocking the pneumatic main line 12 by a main line switching valve 25 (see FIGS. 2A to 10) and, in a third step 2300, conducting compressed air through the branch line in the filling direction B. According to various embodiments, the conducting of compressed air through the branch line in step 2300 furthermore includes firstly opening the branch line 14, 14.1, 14.2 pneumatically to enable the flow to pass through it in the filling direction B.

In the first operating mode B1, the third step 2300 is followed by the provision of the compressed air 141, 142, 140, which is conducted in the branch line 14, 14.1, 14.2, at the compressed air supply port 2, in step 2400.

In the third operating mode B3, the third step 2300 is followed by the return of dehumidified compressed air 140, 142 from the branch line 14, 14.1, 14.2 through the pneumatic main line 12 counter to the filling direction B, in step 2500. Furthermore, step 2500, as sub-step 2510, preferably includes the expansion of compressed air, which is returned counter to the filling direction B, in the pneumatic main line 12.

In the fourth operating mode B4, the third step 2300 is followed by the division of the compressed air 140, 141, which is conducted in the branch line 14, 14.1, 14.2, in such a way that a first portion of the compressed air 140.1 is returned into the pneumatic main line 12 counter to the filling direction B, and, furthermore, a second portion 140.2 of the compressed air 140 is provided at the compressed air supply port 2, in step 2600. This preferably includes receiving control signals and controlling the first portion and the second portion depending on the received control signals via a pneumatic assembly.

In a second operating mode B2, the method, following from the first step 2100, furthermore preferably includes the blocking of the branch line, in step 2700. The method 2000 furthermore includes, following the first step 2100 or the blocking of the branch line in step 2700, in a further step 2800 conducting the compressed air 120 in the filling direction B and drying the compressed air, which is conducted in the pneumatic main line 12 in the filling direction B, and, finally, the provision of the compressed air 120′, which is conducted in the pneumatic main line 12 and is dried, at the compressed air supply port 2.

In the context of the disclosure, it should be understood that the first operating mode B1 denotes a bypass mode, in which compressed air which is not dried or is only partially dehumidified by the water separator 6 is conveyed to the compressed air supply port 2. The second operating mode B2 relates to a basic operating mode in which compressed air dried by the (first) air dryer 5, 5.1 is conveyed to the compressed air supply port 2. The third operating mode B3 relates to a first regeneration mode for regenerating the (first) air dryer, and the fifth operating mode B5 relates to a second regeneration mode for regenerating the second air dryer. The fourth operating mode relates to a distribution mode in which a portion of the compressed air is used for regenerating the first air dryer and the remaining portion of the compressed air, which is partially dehumidified by the water separator 6 or by a second air dryer 5.2, is conveyed to the compressed air supply port 2.

It is understood that the foregoing description is that of the preferred embodiments of the invention and that various changes and modifications may be made thereto without departing from the spirit and scope of the invention as defined in the appended claims.

### REFERENCE SIGNS

1 Compressed air port
2 Compressed air supply port
3 Venting port
5 Air dryer
5.1 First air dryer
5.2 Second air dryer
6 Water separator
7 Branch line throttle
8 Main line throttle
8′ Shifted main line throttle
9 Pressure sensor
11 Branch line regeneration throttle
12 Pneumatic main line
13 Venting line
13.1 First venting line
13.2 Second venting line
13.3 Compressor venting line
14 Branch line
14.1 First branch line
14.2 Second branch line
15 Bypass line
16 Condensation dryer
20 Pneumatic assembly
21 Throttle valve in pneumatic main line
21A Throttle point
21B Control pressure line
23 Venting valve arrangement
23.1 First venting valve
23.2 Venting check valve
23.3 Second venting valve
23.4 Compressor venting valve
23.5 Control valve
23.5A Control line
23.5B Bypass
23.5C Line
24 Branch line switching valve
24.1 Branch line switching valve in branch line
24.2 Third switching valve in branch line
25 Main line switching valve
26 Drain member
27, 27.1, 27.2 First check valve
28, 28.1, 28.2 Second check valve
29, 29.1, 29.2 Return throttle valve
31 Solenoid directional control valve
32 First shut-off valve
34 Second shut-off valve
36 Ventilation device
50 Compressed air source
51 Reservoir
52 Reservoir switching valve
53 Reservoir pressure sensor
60 Temperature sensor
100 Compressed air supply unit
101 Pressure control module
110 Compressed air at the compressed air supply port
120 Partially dehumidified compressed air in pneumatic main line
120′ Dried compressed air in pneumatic main line
131 Moist compressed air in (first) venting line
132 Moist compressed air in second venting line
140 Returned compressed air flow from first and second branch line
140′ Expanded compressed air flow from first and second branch line
140.1 First portion of compressed air, returned compressed air in pneumatic main line
140.2 Second portion of compressed air
141 Compressed air in/out of first branch line
141′ Expanded compressed air in/out of first branch line
142 Compressed air in second branch line
142′ Dried compressed air in/out of second branch line
150 Returned compressed air flow from first branch line and pneumatic main line
150′ Expanded compressed air flow from first branch line and pneumatic main line
200 Compressed air generator
201 Compressing device
201.1 First compressing device
201.2 Second compressing device
202 Compressor
203 Electric motor
203.1 First electric motor
203.2 Second electric motor
300 Pneumatic consumer
301 Sensor cleaning device
302 First nozzle valve
303 Second nozzle valve
304 2/2-way directional control valve
305 Magnetic part
306 Pneumatic part
307 Coil
308.1 Movable armature
308.2 Fixed core
309 Air gap, pole spacing
310 First compressed air passage
311 Second compressed air passage
312 Valve punch part
313 Impact surface
314 Valve spring
315 Valve seat
1000 Vehicle
1100 Passenger car
1200 Compressed air supply system
1300 Control device
1400 Front region of the vehicle
1500 Pneumatic system
2000 Method
2100 Providing compressed air
2200 Blocking the pneumatic main line
2300 Conducting compressed air through the branch line
2310 Opening a branch line
2400 Providing compressed air from the branch line at the compressed air supply port
2500 Returning dehumidified compressed air into the pneumatic main line
2510 Expanding returned compressed air
2600 Distributing compressed air
2700 Blocking the branch line
2800 Conducting and drying compressed air in the pneumatic main line
2900 Providing compressed air from the pneumatic main line at the compressed air supply port
S1 First signal line
S2 Second signal line
S3 Third signal line
S4 Fourth signal line
S Sensor signal
F Direction of travel
B Filling direction
R Return direction
E Venting direction
B1 First operating mode
B2 Second operating mode
B3 Third operating mode
B4 Fourth operating mode
B5 Fifth operating mode
K Condensate
P Pressure
G Degree of saturation
F_{F} Spring force
F_{M} Magnetic force
S_{I} Control current
S_{I1} Opening control current
S_{I2} Holding control current
S_{I3} Heating control current
P_{S} Control pressure
Q Flow cross section

1. A compressed air supply unit for a sensor cleaning device of a vehicle, the compressed air supply unit comprising:
a compressed air port for connection to a compressed air generator;
a compressed air supply port for connection to a sensor cleaning device;
a pneumatic main line for conducting compressed air in a filling direction from said compressed air port to said compressed air supply port;
an air dryer arranged in said pneumatic main line and configured to dry the compressed air which is conducted in the filling direction in the pneumatic main line;
a branch line which branches off from said pneumatic main line between said compressed air port and said air dryer and reconnects between said air dryer and said compressed air supply port;
a pneumatic main line switching valve arranged downstream of said branch line in the filling direction, between said compressed air port and said air dryer in said pneumatic main line; and,
said pneumatic main line switching valve being configured, in a first operating mode, to block said pneumatic main line in the filling direction, and, in a second operating mode, to open said pneumatic main line in the filling direction pneumatically to enable a flow to pass through said pneumatic main line.

2. The compressed air supply unit of claim 1 further comprising:
a pneumatic branch line switching valve arranged in said branch line and configured to selectively block and open said branch line in the filling direction pneumatically to enable the flow to pass through said branch line; or,
a branch line throttle arranged in said branch line and configured to increase a flow resistance of said branch line in relation to said pneumatic main line.

3. The compressed air supply unit of claim 1 further comprising a pneumatic assembly assigned to said compressed air supply port and configured to distribute the compressed air in the compressed air supply unit.

4. The compressed air supply unit of claim 1 further comprising:
a water separator arranged in said pneumatic main line between said compressed air port and said air dryer and said pneumatic main line switching valve; and,
said water separator having a condensation dryer for condensing moist compressed air and a drain member for draining condensate.

5. The compressed air supply unit of claim 4, wherein said water separator is assigned an external ventilation device.

6. The compressed air supply unit of claim 1, wherein said air dryer is a first air dryer and the compressed air supply unit further comprises a second air dryer arranged in said branch line.

7. The compressed air supply unit of claim 1, wherein said branch line is a first branch line and said air dryer is a first air dryer, the compressed air supply unit further comprising:
a second branch line which branches off from said pneumatic main line between said compressed air port and said first air dryer and reconnects between said first air dryer and said compressed air supply port; and,
a second air dryer arranged in said second branch line.

8. The compressed air supply unit of claim 2 wherein said branch line is a first branch line and said air dryer is a first air dryer, the compressed air supply unit further comprising:
a second branch line which branches off from said pneumatic main line between said compressed air port and said first air dryer and reconnects between said first air dryer and said compressed air supply port;
a second air dryer arranged in said second branch line; and,
a main line throttle arranged in said pneumatic main line and configured to interact with said branch line throttle in order, in said first operating mode, to set a volume flow ratio between said pneumatic main line and said branch line.

9. The compressed air supply unit of claim 8, wherein:
said pneumatic branch line switching valve is arranged between said compressed air port and said second air dryer in said second branch line; or,
said second branch line switching valve is arranged in said second branch line between said compressed air port and said second air dryer.

10. The compressed air supply unit of claim 1 further comprising:
a shut-off valve arranged in said pneumatic main line between said air dryer and said compressed air supply port; and,
said shut-off valve being configured to cooperate with said pneumatic main line switching valve and, in said first operating mode, to selectively block a return of the compressed air through said pneumatic main line counter to the filling direction.

11. The compressed air supply unit of claim 10, wherein said branch line is a first branch line and said air dryer is a first air dryer, the compressed air supply unit further comprising:
a pneumatic assembly assigned to said compressed air supply port and configured to distribute the compressed air in the compressed air supply unit;
a second branch line which branches off from said pneumatic main line between said compressed air port and said first air dryer and reconnects between said first air dryer and said compressed air supply port;
a second air dryer arranged in said second branch line;
said shut-off valve being a first shut-off valve;
said pneumatic assembly further having a second shut-off valve arranged between said second air dryer and said compressed air supply port; and,
said second shut-off valve being configured to cooperate with a branch line switching valve and to selectively block a return of the compressed air through said branch line counter to the filling direction.

12. The compressed air supply unit of claim 1 further comprising:
a venting port for venting the compressed air supply unit;
a venting line which branches off from said pneumatic main line to said venting port; and,
a pressure sensor arranged upstream of said venting line in the filling direction and being configured to detect a pressure in said pneumatic main line.

13. The compressed air supply unit of claim 4 further comprising:
a venting port for venting the compressed air supply unit;
a venting line which branches off from said pneumatic main line to said venting port; and,
a pressure sensor arranged upstream of said venting line in the filling direction and being configured to detect a pressure in said pneumatic main line between said water separator and said branching-off branch line.

14. The compressed air supply unit of claim 3, wherein:
said pneumatic assembly includes a controllable throttle valve configured to throttle the compressed air which is conducted in the filling direction to said compressed air supply port;
said throttle valve having a throttle point with a variable flow cross section; and,
said throttle valve having a control pressure line for conducting a control pressure and being configured to regulate the variable flow cross section depending on the control pressure.

15. The compressed air supply unit of claim 3, wherein:
said pneumatic assembly has at least one first check valve opening in the filling direction and a bypass line which branches off downstream of said first check valve and reconnects upstream of said first check valve and has a second check valve opening in the return direction; and,
said pneumatic assembly includes a return throttle valve arranged downstream of said second check valve in the return direction.

16. The compressed air supply unit of claim 1, wherein the vehicle is a passenger car.

17. A compressed air supply system for a sensor cleaning device of a vehicle, the compressed air supply system comprising:
a compressed air generator for providing compressed air to a compressed air port;
a compressed air supply unit connected via said compressed air port to said compressed air generator for providing the compressed air for a sensor cleaning device;
said compressed air supply unit including a compressed air supply port for connection to the sensor cleaning device and a pneumatic main line for conducting the compressed air in a filling direction from said compressed air port to said compressed air supply port;
said compressed air supply unit including an air dryer arranged in said pneumatic main line and configured to dry the compressed air which is conducted in the filling direction in the pneumatic main line;
said compressed air supply unit including a branch line which branches off from said pneumatic main line between said compressed air port and said air dryer and reconnects between said air dryer and said compressed air supply port;
said compressed air supply unit including a pneumatic main line switching valve arranged downstream of said branch line in the filling direction, between said compressed air port and said air dryer in said pneumatic main line; and,
said pneumatic main line switching valve being configured, in a first operating mode, to block said pneumatic main line in the filling direction, and, in a second operating mode, to open said pneumatic main line in the filling direction pneumatically to enable a flow to pass through said pneumatic main line.

18. The compressed air supply system of claim 17 further comprising a compressed air source which is connectable to a control device and being configured to be actuated by the control device for connecting to said pneumatic main line as required.

19. The compressed air supply system of claim 17 further comprising:
a compressed air source which is connectable to a control device and being configured to be actuated by the control device for connecting to said pneumatic main line as required wherein at least one of:
said compressed air generator having a first compressing device and a second compressing device configured to provide the compressed air at said compressed air port; and,
said compressed air source having a reservoir which is fluid-conductingly connected to at least one of said pneumatic main line and said branch line.

20. The compressed air supply system of claim 17, wherein the vehicle is a passenger car.

21. The compressed air supply system of claim 17, wherein said compressed air generator is a compressor.

22. A pneumatic system of a vehicle, the pneumatic system comprising:
the compressed air supply system of claim 17;
a sensor cleaning device connected to said compressed air supply unit via said compressed air supply port; and,
said sensor cleaning device having at least one heatable nozzle valve.

23. The pneumatic system of claim 22, wherein at least one of said valves is configured as normally closed solenoid directional control valves, said at least one valve being at least one of:
said at least one pneumatic main line switching valve;
at least one branch line switching valve;
at least one first nozzle valve;
at least one second nozzle valve;
at least one first venting valve;
at least one second venting valve; and,
a compressor venting valve; and,
said at least one valve having a coil for generating a magnetic force and an armature which is movable by the magnetic force counter to a spring force acting in the direction of a valve seat, and being configured to be moved away from a valve seat counter to the spring force by energizing with an opening control current and to bear against the valve seat by energizing with a heating control current which is smaller than the opening control current, said coil being configured to heat the solenoid directional control valve when the heating control current is present.

24. The pneumatic system of claim 22, wherein the vehicle is a passenger car.

25. A vehicle comprising:
a pneumatic consumer connected to a compressed air supply port;
the compressed air supply system of claim 17 for providing compressed air to said compressed air supply port;
an electronic control device for controlling the compressed air supply system; and,
said electronic control device being signal-conductingly connected at least to said pneumatic main line switching valve.

26. The vehicle of claim 25, wherein said control device is configured to at least one of:
pneumatically connect a compressed air source to said pneumatic main line depending on at least one of:
the supply requirement of said pneumatic consumer;
sensor signals;
sensor signals from a temperature sensor configured to monitor a temperature of the compressed air generator and to providing the sensor signals;
a degree of saturation of the air dryer, the control device being configured to monitor the degree of saturation; and/or,
selectively energize at least one of a following solenoid directional control valves with an opening control current and a heating control current:
the at least one main line switching valve;
at least one branch line switching valve;
a first nozzle valve;
a second nozzle valve;
at least one first and/or second venting valve; and,
a compressor venting valve.

27. The vehicle of claim 25, wherein at least one of the compressed air supply unit, the compressed air generator, a water separator, and a drain member of the water separator is arranged in a front region of the vehicle in a direction of travel.

28. The vehicle of claim 25, wherein said pneumatic consumer is the sensor cleaning device.

29. A method for operating a compressed air supply system comprising:
providing compressed air at a compressed air port connected to a compressed air supply port via a pneumatic main line;
blocking the pneumatic main line in a filling direction in a first operating mode of the pneumatic main line switching valve;
conducting the compressed air through a branch line in the filling direction in the first operating mode, which branch line branches off from the pneumatic main line between the compressed air port and an air dryer and reconnects between the air dryer and the compressed air supply port; and,
providing the compressed air, which is conducted in the branch line, at the compressed air supply port in the first operating mode.

30. The method of claim 29, wherein said providing the compressed air includes, in the first operating mode, opening the branch line pneumatically to enable a flow to pass through it in a direction of the compressed air supply port, the method further comprising:
conducting compressed air in the filling direction and drying the compressed air in the pneumatic main line in a second operating mode;
providing the compressed air, which is conducted in the pneumatic main line, at the compressed air supply port in the second operating mode;
returning compressed air from the branch line such that the compressed air is returned from the branch line into the pneumatic main line counter to the filling direction in a third operating mode;
distributing compressed air from the branch line in a fourth operating mode such that a first portion of the compressed air is returned into the pneumatic main line counter to the filling direction and a second portion of the compressed air is provided at the compressed air supply port.

31. The method of claim 29, wherein the compressed air supply system is for a sensor cleaning device of a vehicle; the compressed air supply system includes:
a compressed air generator for providing the compressed air to the compressed air port;
a compressed air supply unit connected via the compressed air port to the compressed air generator for providing the compressed air for a sensor cleaning device;
the compressed air supply unit including the compressed air supply port for connection to the sensor cleaning device and the pneumatic main line for conducting the compressed air in the filling direction from the compressed air port to the compressed air supply port;
the compressed air supply unit including the air dryer arranged in the pneumatic main line and configured to dry the compressed air which is conducted in the filling direction in the pneumatic main line;
the compressed air supply unit including the branch line;
the compressed air supply unit including a pneumatic main line switching valve arranged downstream of the branch line in the filling direction, between the compressed air port and the air dryer in the pneumatic main line; and,
the pneumatic main line switching valve being configured, in the first operating mode, to block the pneumatic main line in the filling direction, and, in a second operating mode, to open the pneumatic main line in the filling direction pneumatically to enable a flow to pass through the pneumatic main line.

32. The method of claim 30, wherein said conducting the compressed air in the filling direction includes blocking the branch line by a pneumatic branch line switching valve in the second operating mode.
